(19) United States
(12) Patent Application Publication
(10) Pub. No.: US 2021/0116048 A1
(43) Pub. Date: Apr. 22, 2021

(54) NON-ELECTRIC MULTI-CHANNEL VALVE FOR AQUEOUS LIQUIDS OR VAPOR

(71) Applicant: SQUALL E.M.T LTD., Rehovot (IL)

(72) Inventors: Etai ALALI, Karmey Yosef (IL); Tamir RUBIN, Rehovot (IL)

(21) Appl. No.: 17/050,719

(22) PCT Filed: May 1, 2019
(86) PCT No.: PCT/IL2019/050487

§ 371 Date: Oct. 26, 2020

(30) Foreign Application Priority Data
May 3, 2018 (IL) 259128

(51) Int. Cl. F16K 31/524; F16K 11/16; F16K 27/02; F16K 11/22

(52) U.S. Cl. CPC F16K 31/52416; F16K 11/166; F16K 31/524; F16K 27/0263; F16K 11/22; F16K 27/0254

(57) ABSTRACT

The present invention relates to the field of non-electric multi-channel valves adapted to provide specific flow patterns to aqueous fluids or vapor, and, more particularly, to non-electric multi-channel valves configured to provide continuous outflow to aqueous fluids or vapor.

### FIELD OF THE INVENTION

The present invention relates to the field of non-electric multi-channel valves adapted to provide specific flow patterns to aqueous fluids or vapor, and, more particularly, to non-electric multi-channel valves configured to provide continuous outflow to aqueous fluids or vapor.

### BACKGROUND OF THE INVENTION

Valves are widely used in various areas of industrial equipment to control flow direction and flow rate. In certain applications, it is necessary to control several potential flow channels according to desired outflow patterns. In most cases, controlling timely synchronizations between several potential flow channels incorporates using several valves, accompanied by electronic appliances such as servo motors, solenoids and sensors, potentially controlled by an electrically powered flow-control system. Multi-channel valves are widely used in combustion engines, for example, controlling inflow and outflow of non-aqueous liquids, such as oil, fuel or air/fuel mixtures, and incorporate complex structures that include electric components required to provide high accuracy and operational control thereof. The main disadvantages of the aforementioned solutions relate to the complexity of a system consisting of an abundance of interconnected components, the extra space required to accommodate all components, and the cost associated with such configurations, due to either the costs of the multitude of components, or the consumption of electricity from a power source such as batteries or power lines.

Certain applications also require a continuous outflow throughout a flow cycle or during a flow period, such that at each moment, aqueous fluid or vapor may flow through at least one outlet without being obstructed. Continuous outflow is a feature which may also be achieved in current electric multi-channel valves by the aforementioned solutions, adapted to control the opening and closing of each valve separately. Specifically, a flow-control system can include instructions and programing for controlling a multiplicity of valves in a manner that will provide continuous outflow. The addition of specific control schemes or control circuitry may raise costs, further contributing to the complexity of the system, and even require frequent maintenance. The higher complexity may result in inadequate operation of the multi-channel valve device or system, due to occasional dysfunction thereof.

Controlling the outflow of vapor or aqueous liquids such as water, can be useful for a wide variety of application, such as washing appliances, and does not require the high level of control over timing and accuracy as in the aforementioned system for controlling oil or fuel flow. Thus, there is a need for inexpensive devices which can direct flow of aqueous fluid or vapor through different outlets in a controlled manner, which is compact and can be easily implemented even for a high amount of desired channels, while maintaining a requested flow pattern, including the possibility to provide continuous outflow throughout a flow cycle.

### SUMMARY OF THE INVENTION

The following embodiments and aspects thereof are described and illustrated in conjunction with systems, devices and methods which are meant to be exemplary and illustrative, not limiting in scope. In various embodiments, one or more of the above-described problems have been reduced or eliminated, while other embodiments are directed to other advantages or improvements.

According to some embodiments, there is provided a non-electric multi-channel valve for aqueous fluids or vapor having an inlet, a plurality of outlets, and a mechanical driving mechanism powered solely by the aqueous liquid or vapor flowing through the inlet and through at least one of the plurality of outlets, for rotating a first shaft attached thereto. The first shaft includes a plurality of cam elements, aligned with a plurality of seal assemblies, which are in turn aligned with the plurality of outlets. Each seal assembly includes a stem, a seal plug attached to the stem, and a spring disposed around the stem. The seal assemblies are aligned with the outlets, such that the center axes of each stem of a seal assembly and the corresponding outlet coincide, and each seal plug of a seal assembly is movable within the corresponding outlet, from a first position in which the outlet is sealed, to a second position wherein the outlet is unsealed.

Each cam element is configured to intermittently push, directly or indirectly, a corresponding seal assembly, so as to displace the seal plug from the first position to the second position, during a portion of a rotation cycle of the first shaft.

Advantageously, the orientation, size and shape of the cam elements projecting from the first shaft can be configured to provide a desired outflow pattern. More particularly, the orientation, size and shape of the cam elements can be configured to provide a continuous outflow. Thus, eliminating the need to control outflow through the different outlets via electric control means.

A further advantage of the disclosed non-electric multi-channel valve is that the jet stream of aqueous fluid or vapor flowing through the inlet can be utilized to operate the mechanical driving mechanism, thereby eliminating the need to add electric components such as engines or external solenoids, and eliminating the need to provide an external power source.

According to some embodiments, the non-electric multi-channel valve for aqueous fluids or vapor further comprises a second shaft having a plurality of oscillating followers, aligned both with the cam elements and the seal assemblies. Each cam element is rotatably attached to the second shaft, configured to be movable by a corresponding cam element, and in turn push a corresponding seal assembly from a first position towards a second position. Advantageously, the oscillating followers can reduce wear of either the cam elements or at least a portion of the seal assemblies, by serving as intermediate elements that removes any direct contact between the cam elements and the seal assemblies. In order to reduce costs and complexity, the oscillating followers are devoid of any springs or hydraulic components. Preferably, the oscillating followers are configured to be easily removed from the second shaft and replaced in case they wear out, thereby diminishing the need to replace more expansive components, such as cam elements or seal assemblies.

Advantageously, placement of the plurality of oscillating followers on a shaft, such as the second shaft, provides for a simpler structure enabling easier alignment between the oscillating followers and the corresponding cam elements, compared to alternative methods in which each oscillating follower might have been separately connected to the housing, thereby requiring careful alignment between each pair of an oscillating follower and a corresponding cam element.

According to one aspect, there is provided a multi-channel valve comprising a housing having an inlet and a plurality of outlets, each of the plurality of outlets having an outlet proximal edge. The multi-channel valve further comprises a driving mechanism, rotatably attached to the housing. The multi-channel valve further comprises a first shaft attached to the driving mechanism, the first shaft comprising a plurality of cam elements matching the amount of the plurality of outlets and aligned therewith, wherein the plurality of cam elements are rigidly attached to the first shaft, and wherein each of the plurality of cam elements comprises a cam body and a cam head. The multi-channel valve further comprises a plurality of seal assemblies matching the amount of the plurality of outlets and aligned therewith. Each of the plurality of seal assemblies having a seal assembly proximal end and further comprises a stem having a stem proximal end, a seal plug attached to the stem, and a spring disposed around the stem, along at least a portion of a region between the seal plug and the stem proximal end. Further, the first shaft is configured to rotate within the housing, at least two of the cam heads of the plurality of cam elements project radially from the first shaft at different orientations, and each of the plurality of seal assemblies is configured to move between a first position and a second position.

According to some embodiments, the orientation of the plurality of cam elements extending from the first shaft is configured to provide continuous outflow.

According to some embodiments, the driving mechanism comprises an impeller aligned with the inlet, and a gear train attached to the impeller.

According to some embodiments, the impeller comprises a turbine.

According to some embodiments, the gear train comprises a gear shaft affixed to the impeller, a first gear attached to the gear shaft configured to rotate therewith, and a second gear engaged with and configured to be driven by the first gear. Further, the first shaft is rigidly connected to the second gear, and is configured to rotate therewith.

According to some embodiments, the plurality of outlets comprises at least five outlets.

According to some embodiments, the plurality of outlets comprises at least eight outlets.

According to some embodiments, the plurality of outlets comprises at least fifteen outlets.

According to some embodiments, each of the plurality seal assemblies further comprises a proximal retainer and a distal retainer, rigidly attached to the stem, wherein a corresponding seal plug of the plurality of seal plugs is retained between the proximal retainer and the distal retainer.

According to some embodiments, each of the plurality of seal plugs is formed with a cylindrical convexly curved shape.

According to some embodiments, each of the plurality of stems further comprises a gasket engaged therewith, configured to contact and support a corresponding spring of the plurality of springs.

According to some embodiments, the gasket comprises an O-ring.

According to some embodiments, each of the plurality of seal assemblies further comprises a split pin, wherein a corresponding stem of the plurality of stems further comprises a stem aperture, configured to receive one of the plurality of split pins.

According to some embodiments, each of the plurality of springs is a compression spring.

According to some embodiments, the housing further comprises a plurality of outlet supports matching the amount of the plurality of outlets and aligned therewith, wherein each of the plurality of outlet supports is formed around a corresponding outlet proximal edge from the plurality of outlets.

According to some embodiments, each of the plurality of outlet supports is formed as a shoulder.

According to some embodiments, each of the plurality of outlet supports is configured to support a corresponding spring of the plurality of springs, placed thereon.

According to some embodiments, each of the plurality of outlet supports further comprises at least one support rib, configured to support a corresponding spring of the plurality of springs, placed thereon.

According to some embodiments, each of the plurality of springs is an extension spring.

According to some embodiments, each of the plurality of outlets further comprises an outlet neck portion having a neck distal shoulder, wherein each of the plurality of springs is positioned against the corresponding neck distal shoulder of the plurality of outlets.

According to some embodiments, each of the plurality of cam heads is configured to engage a corresponding seal assembly proximal end from the plurality of seal assemblies during a portion of a rotational cycle, thereby pushing the corresponding seal assembly in the distal direction.

According to some embodiments, the multi-channel valve further comprises a second shaft rigidly attached to the housing, the second shaft comprising a plurality of oscillating followers matching the amount of the plurality of outlets. Further, each of the plurality of oscillating followers is having a follower proximal surface and a follower base surface, each of the plurality of oscillating followers are rotatably attached to the second shaft, and the plurality of oscillating followers are aligned with the plurality of cam elements and with the plurality of seal assemblies.

According to some embodiments, each of the plurality of cam heads is configured to engage a corresponding follower proximal portion during a portion of a rotational cycle, resulting in an arcuate motion of the corresponding oscillating follower about the second shaft, wherein the corresponding follower base surface is configured to push a corresponding seal assembly proximal end from the plurality of seal assemblies in a distal direction, during at least a portion of said arcuate motion.

According to some embodiments, each of the plurality of oscillating followers further comprises a follower extension, rigidly attached to the follower base surface.

According to some embodiments, each of the plurality of oscillating followers further comprises a follower bore.

According to some embodiments, the second shaft further comprises a plurality of clamps matching the amount of oscillating followers and aligned therewith, wherein each of the plurality of clamps is formed as a tube abutting the second shaft, and each of the plurality of clamps is configured to be received within a corresponding follower bore of the plurality of oscillating followers.

According to some embodiments, at least one of the plurality of stems further comprises a stem proximal portion, formed with a frustoconical profile.

According to some embodiments, at least one of the plurality of stems further comprises a seal proximal cover, shaped in the form of a dome.

According to some embodiments, at least two of the plurality of outlets are oriented in different directions.

According to some embodiments, at least two couples of adjacent outlets of the plurality of outlets are spaced from one another at unequal distances.

Certain embodiments of the present invention may include some, all, or none of the above advantages. Further advantages may be readily apparent to those skilled in the art from the figures, descriptions, and claims included herein. Aspects and embodiments of the invention are further described in the specification herein below and in the appended claims.

Unless otherwise defined, all technical and scientific terms used herein have the same meaning as commonly understood by one of ordinary skill in the art to which this invention pertains. In case of conflict, the patent specification, including definitions, governs. As used herein, the indefinite articles “a” and “an” mean “at least one” or “one or more” unless the context clearly dictates otherwise.

The following embodiments and aspects thereof are described and illustrated in conjunction with systems, tools and methods which are meant to be exemplary and illustrative, but not limiting in scope. In various embodiments, one or more of the above-described problems have been reduced or eliminated, while other embodiments are directed to other advantages or improvements.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1A constitutes a view in perspective of a non-electric multi-channel valve for aqueous fluids or vapor, according to some embodiments.

FIG. 1B constitutes a view in perspective of a non-electric multi-channel valve for aqueous fluids or vapor without a read wall of the first housing portion and without the top wall of the second housing portion, according to some embodiments.

FIG. 1C constitutes a cross-sectional side view of a non-electric multi-channel valve for aqueous fluids or vapor, according to some embodiments.

FIG. 2A constitutes a view in perspective of internal components of a non-electric multi-channel valve for aqueous fluids or vapor, without a housing, according to some embodiments.

FIG. 2B constitutes a partial view in perspective of the internal components of the non-electric multi-channel valve for aqueous fluids or vapor of FIG. 2A.

FIG. 2C constitutes a front view of the internal components of the non-electric multi-channel valve for aqueous fluids or vapor of FIG. 2A.

FIG. 3A constitutes a view in perspective of a first shaft, according to some embodiments.

FIG. 3B constitutes a view in perspective of variation of a first shaft, according to some embodiments.

FIG. 3C constitutes a view in perspective of variation of a first shaft, according to some embodiments.

FIG. 4A constitutes a view in perspective of a cam follower with a corresponding seal assembly, according to some embodiments.

FIG. 4B constitutes a view in perspective of a cam follower with a variation of a corresponding seal assembly, according to some embodiments.

FIG. 4C constitutes a view in perspective of a variation of a cam follower with a corresponding seal assembly, according to some embodiments.

FIG. 5 constitutes a view in perspective of a clamp, according to some embodiments.

FIG. 6 constitutes a view in perspective of a seal assembly, according to some embodiments.

FIG. 7 constitutes a side view in perspective of internal components of a non-electric multi-channel valve for aqueous fluids or vapor, without a housing, according to some embodiments.

FIG. 8 constitutes a partial side view of a couple of seal assemblies in first and second positions, according to some embodiments.

FIG. 9A constitutes a top view of a housing, without the top wall of the second housing portion, according to some embodiments.

FIG. 9B constitutes a top view of a variation of a housing, without the top wall of the second housing portion, according to some embodiments.

FIG. 9C constitutes a cut-away view in perspective of the housing of FIG. 9B.

FIG. 9D constitutes a cross-sectional side view of the housing of FIG. 9B.

FIG. 10 constitutes a cut-away view in perspective of a non-electric multi-channel valve for aqueous fluids or vapor, according to some embodiments.

FIG. 11 constitutes a partial side view of a couple of seal assemblies in first and second positions, according to some embodiments.

FIG. 12A constitutes a cut-away view in perspective of a non-electric multi-channel valve for aqueous fluids or vapor, according to some embodiments.

FIG. 12B constitutes a view in perspective of internal components of the non-electric multi-channel valve for aqueous fluids or vapor of FIG. 12A, without a housing, according to some embodiments.

FIG. 13 constitutes a partial side view of a couple of seal assemblies in first and second positions, according to some embodiments.

FIG. 14A constitutes a cut-away view in perspective of a non-electric multi-channel valve for aqueous fluids or vapor, according to some embodiments.

FIG. 14B constitutes a cross-sectional side view of the non-electric multi-channel valve for aqueous fluids or vapor of FIG. 14A.

FIG. 15 constitutes a partial side view of a couple of seal assemblies in first and second positions, according to some embodiments.

FIG. 16A constitutes a view in perspective of a non-electric multi-channel valve for aqueous fluids or vapor, according to some embodiments.

FIG. 16B constitutes a front view of the non-electric multi-channel valve for aqueous fluids or vapor of FIG. 16A.

FIG. 17A constitutes a side view in perspective of a non-electric multi-channel valve for aqueous fluids or vapor, according to some embodiments.

FIG. 17B constitutes a front view in perspective of the non-electric multi-channel valve for aqueous fluids or vapor of FIG. 17A.

### DETAILED DESCRIPTION OF SOME EMBODIMENTS

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure. In the figures, like reference numerals refer to like parts throughout.

Throughout the figures of the drawings, different superscripts for the same reference numerals are used to denote different embodiments of the same elements. Embodiments of the disclosed devices and systems may include any combination of different embodiments of the same elements. Specifically, any reference to an element without a superscript may refer to any alternative embodiment of the same element denoted with a superscript. Components having the same reference number followed by different lowercase letters may be collectively referred to by the reference number alone. If a particular set of components is being discussed, a reference number without a following lowercase letter may be used to refer to the corresponding component in the set being discussed. In order to avoid undue clutter from having too many reference numbers and lead lines on a particular drawing, some components will be introduced via one or more drawings and not explicitly identified in every subsequent drawing that contains that component.

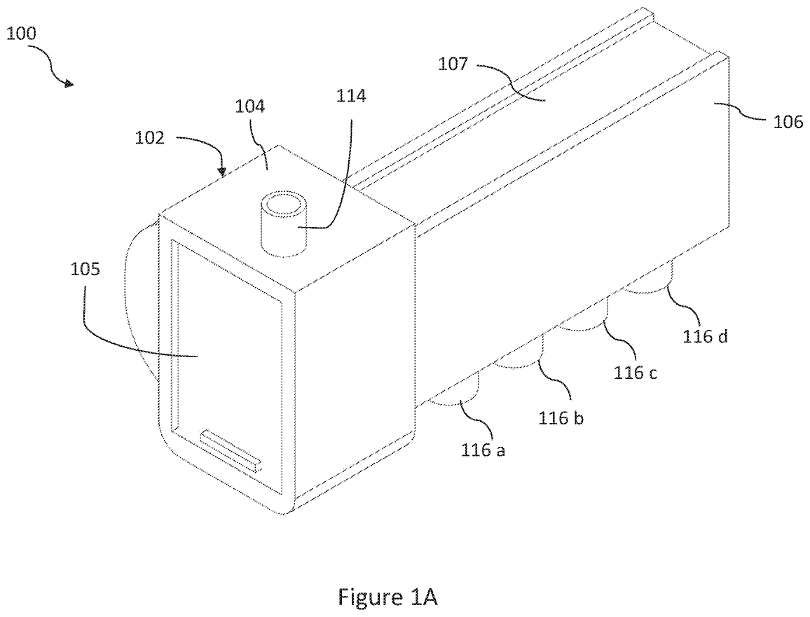

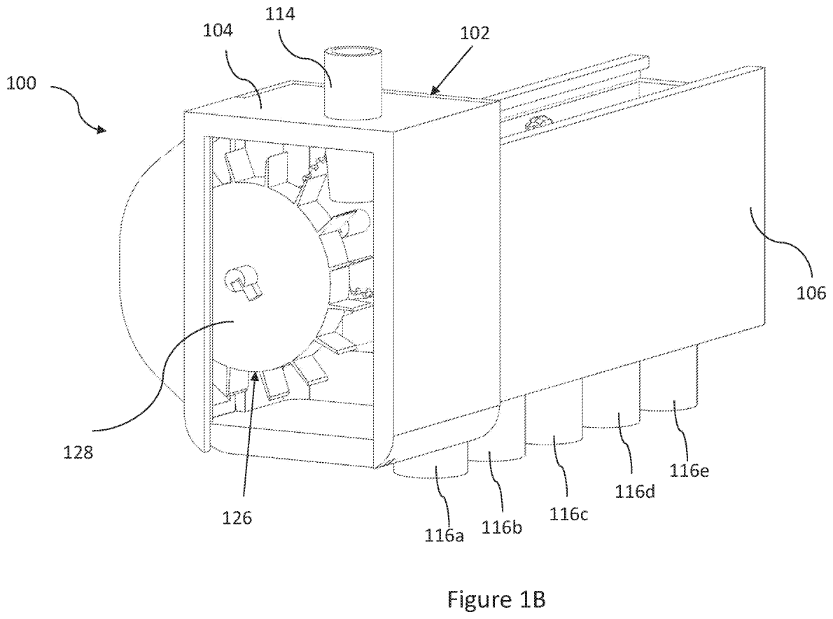

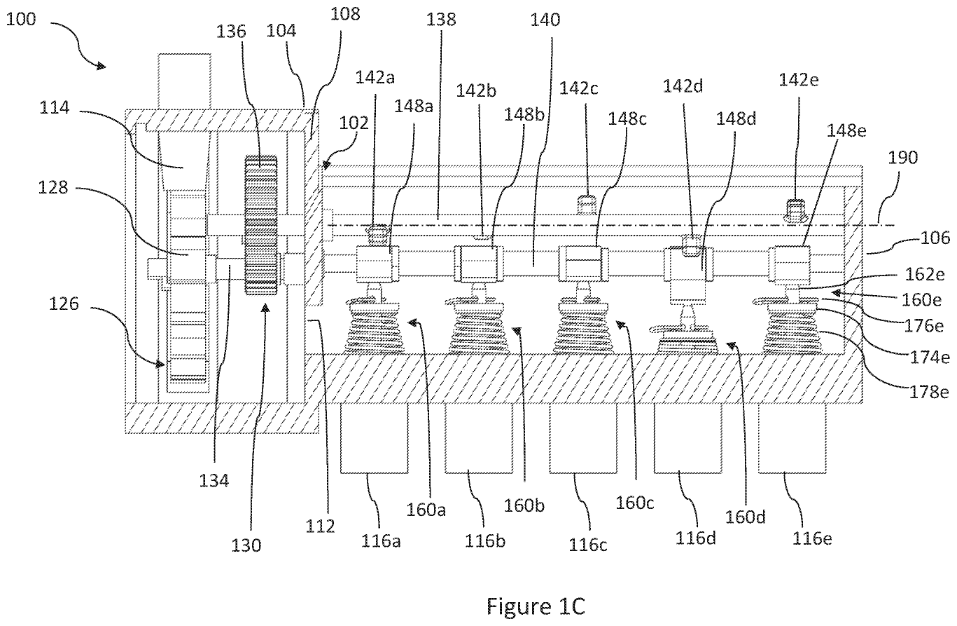

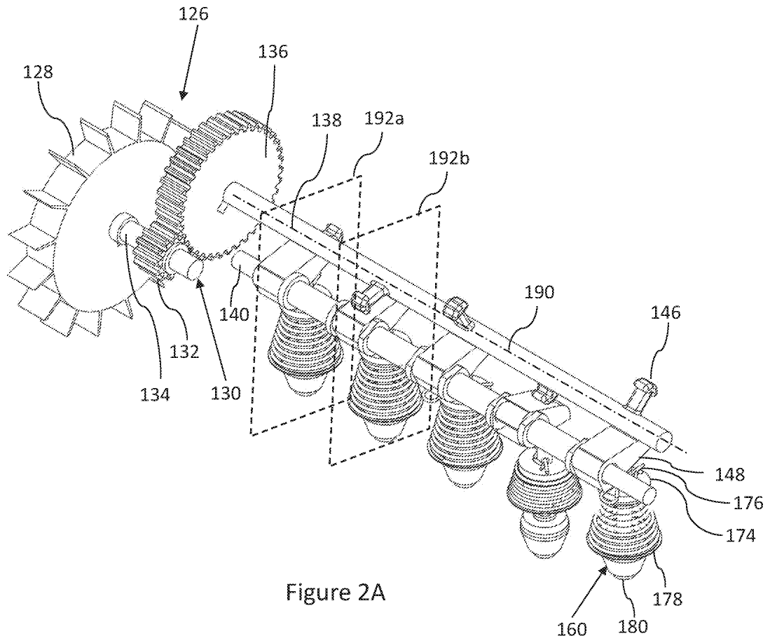

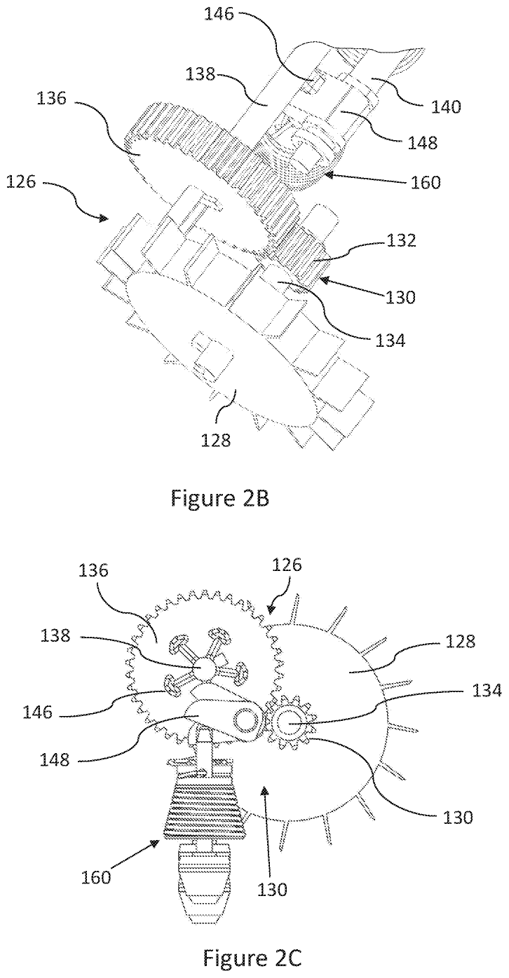

Reference is now made to FIGS. 1A-2C. FIG. 1A constitutes a view in perspective of a non-electric multi-channel valve for aqueous fluids or vapor 100, according to some embodiments. Non-electric multi-channel valve for aqueous fluids or vapor 100 comprises a housing 102. Housing 102 comprises an inlet 114 and a plurality of outlets 116. According to some embodiments, housing 102 comprises a first housing portion 104 and a second housing portion 106, such that first housing portion 104 comprises inlet 114, and second housing portion 106 comprises the plurality of outlets 116. According to some embodiments, housing 102 further comprises a flow passage 112 (see FIG. 1C) configured to allow aqueous fluid or vapor flow there through, from first housing portion 104 to second housing portion 106. According to some embodiments, first housing portion 104 and second housing portion 106 are rigidly attached to each other. According to some embodiments, first housing portion 104 and second housing portion 106 are integrally formed.

According to some embodiments, first housing portion 104 comprises a rear wall 105. According to some embodiments, rear wall 105 is detachably attached to first housing portion 104. According to some embodiments, rear wall 105 is integrally formed with first housing portion 104.

According to some embodiments, second housing portion 106 comprises a top wall 107. According to some embodiments, top wall 107 is detachably attached to second housing portion 106. According to some embodiments, top wall 107 is integrally formed with second housing portion 106.

FIG. 1B constitutes a view in perspective of non-electric multi-channel valve for aqueous fluids or vapor 100, with rear wall 105 and top wall 107 removed from view to expose some of the internal components thereof, according to some embodiments. FIG. 1C constitutes a cross-sectional side view of non-electric multi-channel valve for aqueous fluids or vapor 100, according to some embodiments.

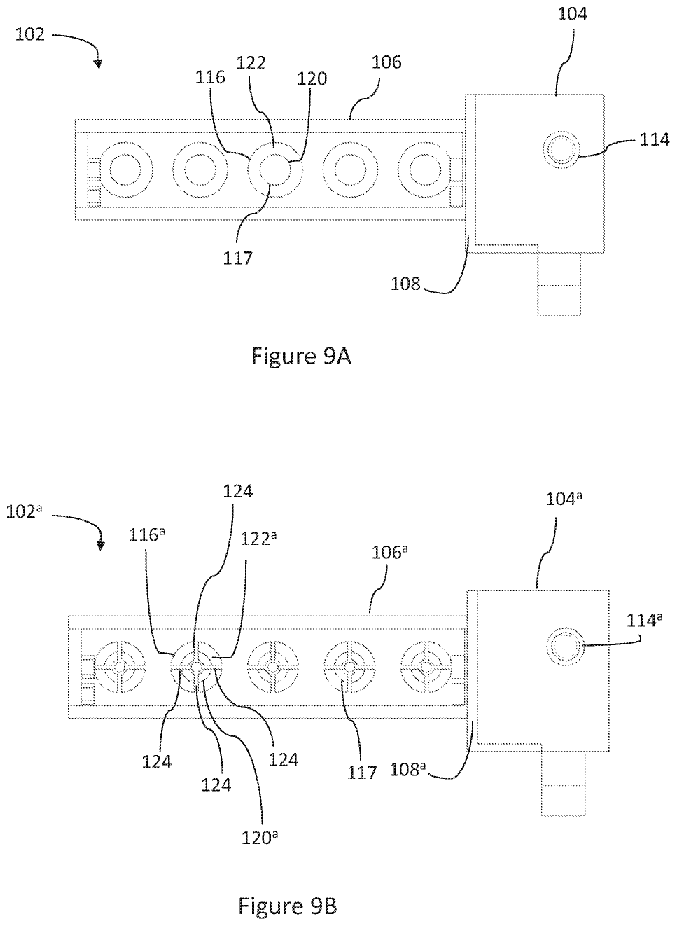

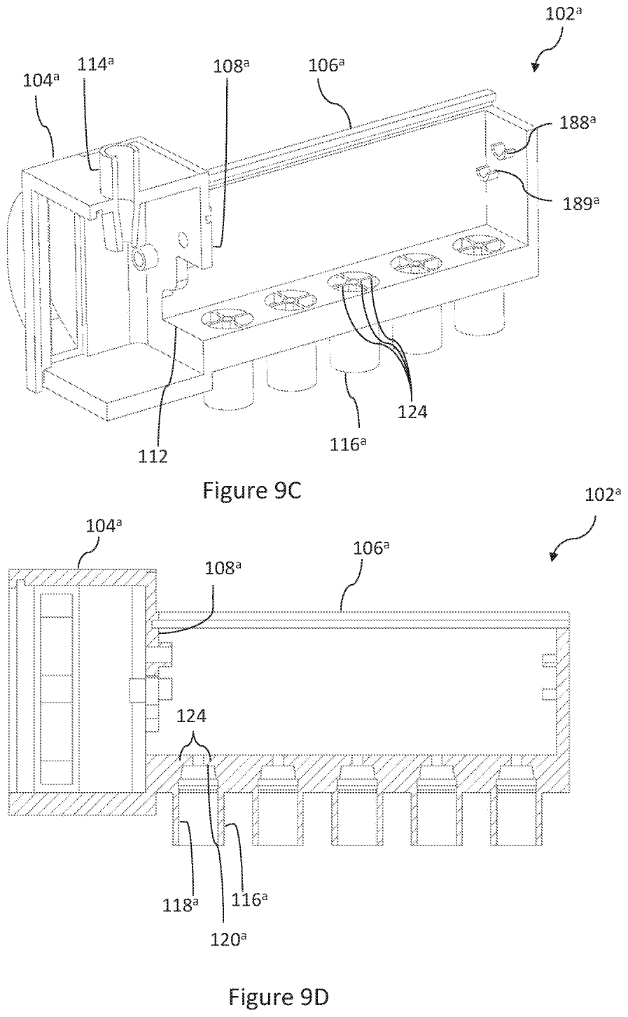

According to some embodiments, housing 102 further comprises a mount 108 supported by first housing portion 104. Mount 108 comprises a through-hole (not numbered) sized and shaped to receive and support first shaft 138 there through (see FIGS. 1C and 9C-9D). According to some embodiments, mount 108 is supported by second housing portion 106 instead of first housing portion 104 (embodiment not shown).

According to some embodiments, housing 102 further comprises a first seating 188 (see for example in FIG. 9C) rigidly attached to a wall (not numbered) opposite to mount 108, configured to receive an end (not numbered) of first shaft 138 thereon. According to some embodiments, housing 102 further comprises a second seating 189 (see for example in FIG. 9C) rigidly attached to a wall (not numbered) opposite to mount 108, configured to receive an end (not numbered) of second shaft 140 thereon.

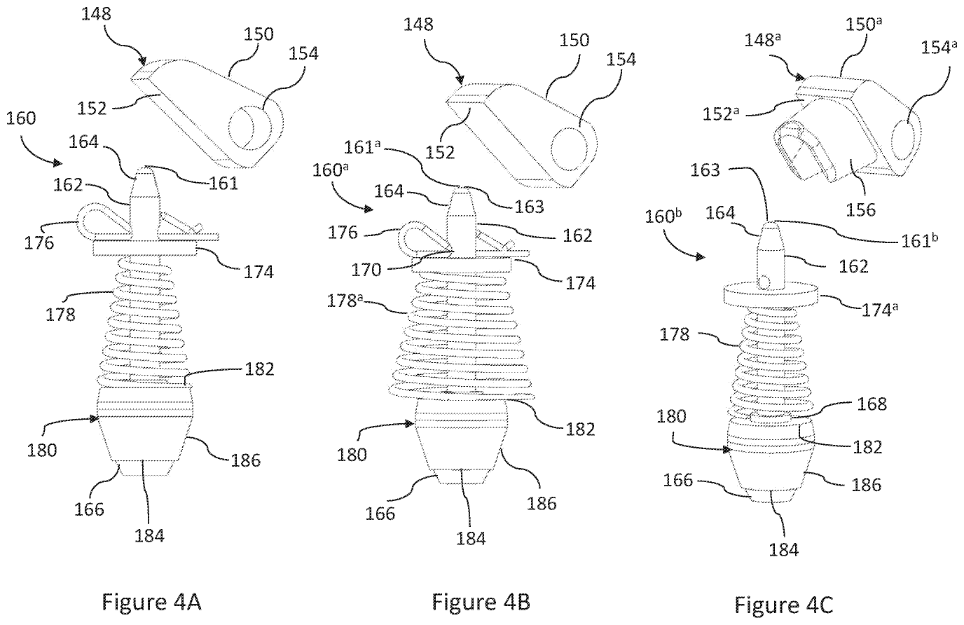

Non-electric multi-channel valve for aqueous fluids or vapor 100 comprises a mechanical driving mechanism 126 connected to and rotatable within housing 102, a first shaft 138 attached to mechanical driving mechanism 126, and a plurality of seal assemblies 160 matching the amount of outlets 116 and aligned therewith. Each seal assembly 160, having a seal assembly proximal end 161 (hidden from view in FIGS. 1A-2B but visible in FIG. 4A), is configured to move between a first position and a second position (to be defined), wherein movement from first position towards second position is facilitated directly or indirectly (terms are later defined herein) by first shaft 138 and movement back to first position is facilitated by springs 178.

First shaft center-axis 190 (see FIGS. 1C and 2A) is the axis of symmetry of first shaft 138. A vertical plane 192 (see FIG. 2A) is defined as a plane which is perpendicular to first shaft center-axis 190. Two parallel vertical planes, specifically vertical plane 192a and vertical plane 192b, are depicted in FIG. 2A. The term “symmetry plane”, as used herein, refers to a vertical plane passing through a component or an assembly, such that both portions of the same component or assembly are symmetrical from both sides of the plane.

The term “aligned”, as used herein, refers symmetry planes of corresponding components or assemblies, which essentially coincide along the same vertical planer. For example, seal assembly 160a is aligned with outlet 116a if their symmetry planes essentially coincide with vertical plane 192a. Since perfect alignment is sometimes difficult to achieve, the term “essentially coincides” refers also to cases in which both symmetry planes are angled up to 10 degrees relative to each other, such that both planes still intersect with each other in a region within housing 102.

A plurality of components are “aligned” with a plurality of other components, if each of the plurality of components is aligned with a corresponding other component. For example, seal assemblies 160 are aligned with outlets 116, if each seal assembly 160 is aligned with a specific, corresponding outlet 116.

The term plurality, as used herein, refers to more than one.

The terms “each of” and “each of the plurality of”, as used herein, are interchangeable.

The terms “seal assembly” and “the plurality of seal assemblies”, as used herein, are interchangeable.

First shaft 138 comprises a plurality of cam elements 142, matching the amount of seal assemblies 160 and aligned therewith. According to some embodiments, first shaft 138 is a cam shaft.

The terms “cam elements” and “the plurality of cam elements”, as used herein, are interchangeable.

The term “corresponding”, as used herein to describe a relationship between one of a plurality of components and one of the plurality of other components, refers to a specific component from the plurality of components, which is aligned with the specific other component from the plurality of other components.

FIGS. 1B-2C depict exemplary embodiments of a non-electric multi-channel valve for aqueous fluids or vapor 100 comprising five outlets 116a, 116b, 116c, 116d and 116e, with five corresponding seal assemblies 160a, 160b, 160c, 160d and 160e. However, it will be understood by those skilled in the art that non-electric multi-channel valve for aqueous fluids or vapor 100 may comprise any other amount of outlets with corresponding seal assemblies, such as two, four, eight, twelve and so on.

Advantageously, the non-electric multi-channel valve for aqueous fluids or vapor 100 disclosed herein, can be easily adapted to include a large number of outlets without modifying the working principles disclosed or the complexity of operation. According to some embodiments, non-electric multi-channel valve for aqueous fluids or vapor 100 comprises at least two outlets. According to some embodiments, non-electric multi-channel valve for aqueous fluids or vapor 100 comprises at least four outlets. According to some embodiments, non-electric multi-channel valve for aqueous fluids or vapor 100 comprises at least five outlets. According to some embodiments, non-electric multi-channel valve for aqueous fluids or vapor 100 comprises at least eight outlets. According to some embodiments, non-electric multi-channel valve for aqueous fluids or vapor 100 comprises at least twelve outlets. According to some embodiments, non-electric multi-channel valve for aqueous fluids or vapor 100 comprises at least fifteen outlets. According to some embodiments, non-electric multi-channel valve for aqueous fluids or vapor 100 comprises at least twenty outlets.

According to some embodiments, non-electric multi-channel valve for aqueous fluids or vapor 100 further comprises a second shaft 140, rigidly connected to housing 102. Second shaft 140 comprises a plurality of oscillating followers 148, matching the amount of cam elements 142, such that each of the plurality of oscillating followers 148 is rotatably attached to second shaft 140. Oscillating followers 148 are aligned with cam elements 142 and with seal assemblies 160. More specifically, each oscillating follower 148 is aligned with and configured to be rotatable by a corresponding cam element 142, and is also aligned with and configured to push a corresponding seal assembly 160 from a first position towards a second position (terms are later defined herein).

The terms “oscillating followers” and “the plurality of oscillating followers”, as used herein, are interchangeable.

Non-electric multi-channel valve for aqueous fluids or vapor 100 is configured to contain only a single flowing material at a time, which is either an aqueous fluid or vapor, and is devoid of oil or oiling fluids flowing there through at all times, and devoid of a separate oiling system for oiling any of its components.

Advantageously, the incorporation of oscillating followers 148 into non-electric multi-channel valve for aqueous fluids or vapor 100 can reduce wear of either cam elements 142 or at least a portion of seal assemblies 160, by serving as intermediate elements that prevents direct contact between cam elements 142 and seal assemblies 160. Reducing wear of components is particularly important in a device configured to contain and direct the flow of an aqueous fluid or vapor, such as non-electric multi-channel valve for aqueous fluids or vapor 100, devoid of oil or oiling fluids flowing there through, and devoid of a separate oiling system for oiling any of its components.

In order to reduce costs and complexity, oscillating followers 148 are devoid of any springs or hydraulic components, as there is no need to provide lash control or adjustment in non-electric multi-channel valve for aqueous fluids or vapor 100.

Advantageously, placement of all oscillating followers 148 on a single shaft, such as the second shaft 140, provides for a simpler structure enabling easier alignment between oscillating followers 148 and corresponding cam elements 142 and/or seal assemblies 160, compared to alternative methods in which each oscillating follower might have been separately connected to the housing, thereby requiring careful alignment between each oscillating follower and a corresponding cam element, or between each oscillating follower and a corresponding seal assembly.

FIGS. 2A, 2B and 2C constitute a view in perspective, a partial view in perspective and a front view, respectively, of the internal components of non-electric multi-channel valve for aqueous fluids or vapor 100, according to some embodiments, wherein housing 102 is removed from view for clarity.

Mechanical driving mechanism 126 comprises an impeller 128 and is configured to be powered by the aqueous fluids or vapor flowing into the housing through the inlet and out of the housing through at least one of the plurality of outlets. According to some embodiments, mechanical driving mechanism 126 further comprises a gear train 130 attached thereto. According to some embodiments, gear train 130 comprises a gear shaft 134 affixed to impeller 128, a first gear 132 attached to impeller 128 via gear shaft 134, configured to rotate therewith, and a second gear 136 engaged with and configured to be driven by first gear 132. First shaft 138 is rigidly connected to second gear 136, and is configured to rotate therewith.

Impeller 128 is aligned with inlet 114 and configured to rotate as a consequence of aqueous fluid or vapor flowing from inlet 114. According to some embodiments, impeller 114 comprises radial vanes (not numbered) impinged upon by a jet of flow entering through inlet 114. According to some embodiments, impeller 128 comprises a turbine.

While FIGS. 2A-2C depict embodiments of a specific gear train with two gears, it will be understood by those skilled in the art that other gear trains can be implemented, including any set of interworking gears, racks, pulleys and gear assemblies, configured to transform rotational motion of impeller 128 to rotational motion of first shaft 138.

Advantageously, a mechanical driving mechanism 126 driven by the aqueous fluid or vapor flowing entering through inlet 114, which is the same aqueous fluid or vapor flowing through at least one of outlets 116, makes the use of electric engines redundant, and exploits the kinetic energy of the aqueous fluid or vapor entering a non-electric multi-channel valve for aqueous fluids or vapor 100 to operate it, thereby simplifying its structure and reducing costs.

The term “fluid flow”, as used herein, refers to flow of aqueous liquid or vapor. Cam elements 142 are rigidly attached to first shaft 138, such that at least two different cam heads 146 of the plurality of cam elements 142 project radially from first shaft 138 at different orientations. The exemplary embodiment of FIG. 2C depicts each of five cam elements 142 (four of which are visible, while the fifth is hidden by oscillating followers 148) projecting radially from first shaft 138 at a different orientation.

Each oscillating follower 148 is free to rotate about second shaft 140, such that when first shaft 138 rotates, each cam element 142 contacts a corresponding oscillating follower 148 during a portion a rotational cycle, followed by a corresponding rotational motion of the oscillating follower 148 in a direction opposite to the rotation of first shaft 138.

The terms “rotation cycle”, “rotational cycle” or “complete rotational cycle”, as used herein, are interchangeable, and refer to a single complete rotational cycle of first shaft 138.

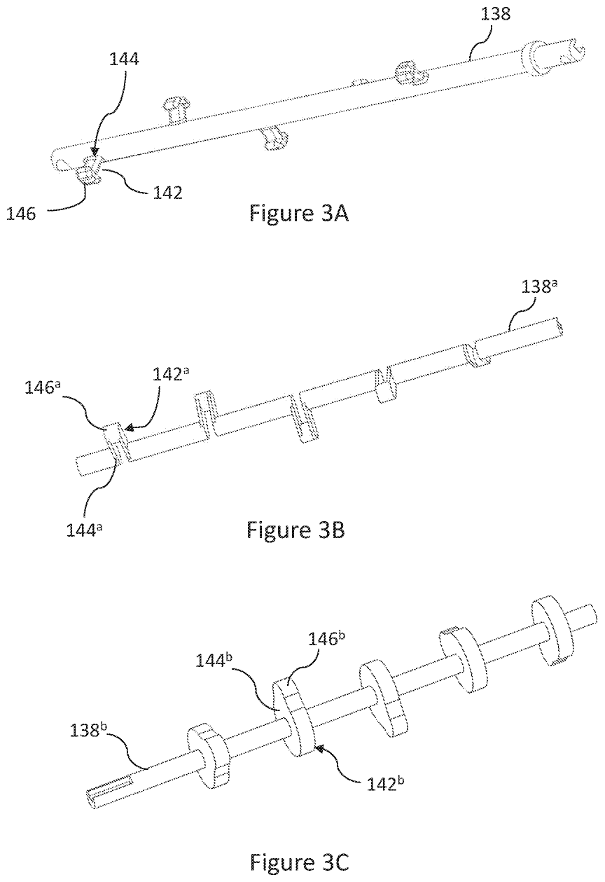

Reference is now made to FIGS. 3A-3C, depicting different embodiments of first shaft 138. Each of the plurality of cam elements 142 comprises a cam body 144 by which it is affixed to of first shaft 138, and a cam head 146 projecting radially from cam body 144 and configured to contact either oscillating follower 148 or seal assembly 160 during a portion of a rotational cycle. FIG. 3A depicts an embodiment of cam element 142, comprising a longitudinal cam body 144 extending radially from first shaft 138, and a cam head 146 formed as a hammer head attached to cam body 144. FIG. 3B depicts an embodiment of cam element 142^{a}, comprising a longitudinal cam body 144^{a} extending radially from first shaft 138^{a}, and a cam head 146^{a} formed as an arcuate ending of cam body 144^{a}. FIG. 3C depicts an embodiment of cam element 142^{b}, comprising a cam body 144^{b} circumferentially disposed around first shaft 138^{b}, and a cam head 146^{b} formed as lobe extending from cam body 144^{b}.

According to some embodiments, cam elements 142 are integrally formed with first shaft 138. According to some embodiments, cam elements 142 are detachably attached to first shaft 138, such that each single cam element 142 can be detached and replaced, for example due to wear over time.

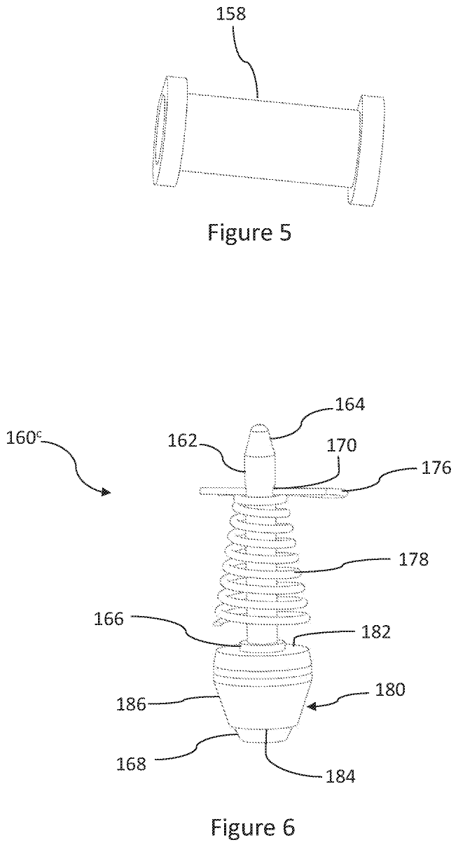

Reference is now made to FIGS. 4A-6. FIGS. 4A-4C depict different embodiments of oscillating follower 148 with seal assembly 160. FIG. 5 depicts a clamp 158. FIG. 6 depicts another embodiment of seal assembly 160. Oscillating follower 148 comprises a follower proximal surface 150, a follower base surface 152 and a follower bore 154. Follower bore 154 is configured to receive either second shaft 140 or clamp 158 (explained here forth).

According to some embodiments, second shaft 140 comprises a plurality of clamps 158, matching the amount of oscillating followers 148 and aligned therewith. Each clamp 158 is formed as a tube (see FIG. 5) abutting second shaft 140. Clamp 158 comprises a shoulder (not numbered, see FIG. 5) around each end thereof, and is dimensioned between both shoulders to receive oscillating follower 148, such that when oscillating follower 148 abuts clamp 158, received through follower bore 154, both shoulders of clamp 158 prevent lateral movement of a corresponding oscillating follower 148 along the length of second shaft 140.

According to some embodiments, second shaft 140 is received directly through the follower bores 154 of oscillating followers 148 (embodiment not shown), wherein a plurality of clamps (not shown) are affixed to second shaft 140, one at each side of each oscillating followers 148, so as to prevent lateral movement of oscillating follower 148 along the length of second shaft 140.

According to some embodiments, second shaft 140 is formed with a plurality of shoulders (embodiment not shown) rigidly attached thereto or integrally formed therewith, such that second shaft 140 is received directly through the plurality of follower bores 154, wherein each two shoulders confine both ends of follower bore 154 so as to prevent lateral movement of a corresponding oscillating follower 148 along the length of second shaft 140.

According to some embodiments, oscillating followers 148 are detachably attached to second shaft 140 or to corresponding clamps 158, such that each single oscillating follower 148 can be detached and replaced, for example due to wear over time.

According to some embodiments, each cam head 146 is configured to engage a corresponding follower proximal portion 150 during a portion of a rotational cycle, resulting in an arcuate motion of the corresponding oscillating follower 148 about second shaft 140 from the start of engagement between cam head 146 and follower proximal portion 150, until disengagement thereof, along an arcuate pathway (not shown) of oscillating follower 148 towards a corresponding outlet 116. During at least a portion of the above mentioned arcuate motion of the corresponding oscillating follower 148, the corresponding follower base surface 152 contacts the corresponding of seal assembly proximal end 161, thereby pushing the corresponding seal assembly 160 in the distal direction. Thus, a rotational motion of first shaft 138 is translated, via second shaft 140, to a liner motion of seal assembly 160. In particular, movement of seal assembly 160 from first position towards second position (terms are later defined herein) is facilitated indirectly by first shaft 138, when such movement is mediated via a corresponding oscillating follower 148.

Seal assembly 160 comprises a stem 162 having a stem proximal end 163, a seal plug 180 rigidly attached to stem 162, and a spring 178 disposed around stem 162, along at least a portion of a region between seal plug 180 and stem proximal end 163. Seal plug 180 comprises a seal plug proximal surface 182, a seal plug distal surface 184 and a seal plug circumferential surface 186.

Within the context of this application the term “proximal” generally refers to the side or end of any device, a component of a device or an assembly, which is closer to first shaft center-axis 190. More particularly, seal assembly proximal end 161 is the end which is closer to first shaft center-axis 190 when installed within housing 102.

Within the context of this application the term “distal” generally refers to the side or end of any device, a component of a device or an assembly, which is opposite the “proximal end”, and is farther from first shaft center-axis 190.

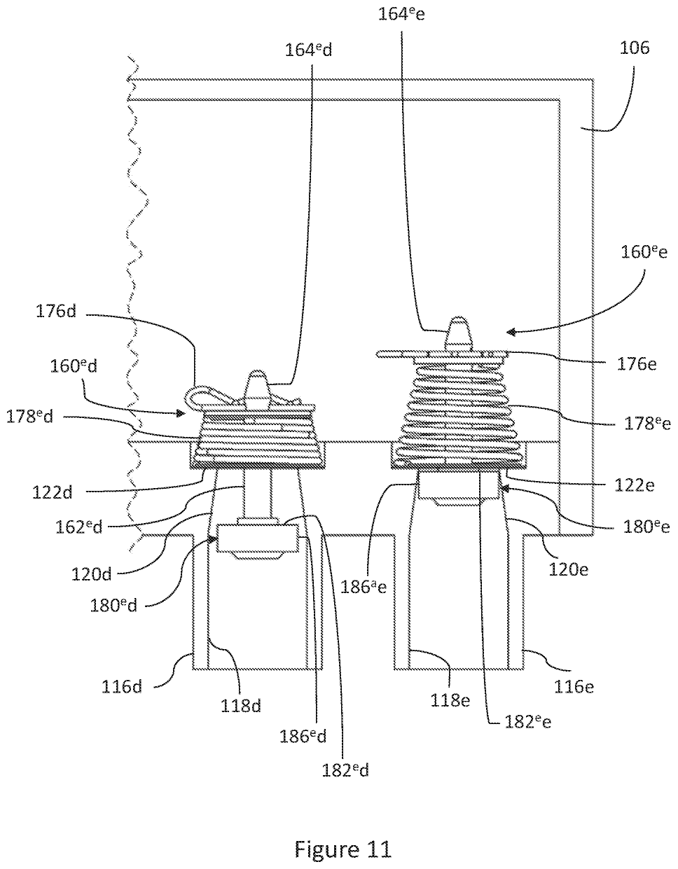

According to some embodiments, seal plug 180 is formed with a conical or a frustoconical shape. According to some embodiments, seal plug 180 is formed with a cylindrical shape. According to some embodiments, seal plug 180 is formed with a cylindrical convexly curved shape. According to some embodiments, the diameter of seal plug proximal surface 182 is different from the diameter of seal plug distal surface 184 (see FIGS. 4A-4C). According to some embodiments, the diameter of seal plug proximal surface 182 is larger than the diameter of seal plug distal surface 184 (see FIGS. 4A-4C). According to some embodiments, the diameter of seal plug proximal surface 182 is smaller than the diameter of seal plug distal surface 184 (embodiment not shown). According to some embodiments, the diameter of seal plug proximal surface 182 is equal to the diameter of seal plug distal surface 184 (see FIG. 11). According to some embodiments, seal plug 180 is formed with a varying diameter, such that the largest diameter (not numbered) along seal plug 180 is larger than any of seal plug proximal surface 182 and seal plug distal surface 184.

Advantageously, a cylindrical convexly curved shape of seal plug 180 promotes favorable flow patterns of fluid flow around seal plug circumferential surface 186.

According to some embodiments, seal assembly 160 further comprises a stem proximal retainer 168 and a stem distal retainer 166, rigidly attached to stem 162 such that seal plug 180 is retained there between. Stem proximal retainer 168 is configured to contact seal plug proximal surface 182, thereby preventing further displacement of seal plug 180 along stem 162 in the proximal direction. Stem distal retainer 166 is configured to contact seal plug distal surface 184, thereby preventing further displacement of seal plug 180 along stem 162 in the distal direction.

According to some embodiments, stem 162 comprises a stem proximal portion 164, configured to be contacted and pushed distally by either a corresponding follower base surface 152 during at least a portion of the arcuate motion thereof, or by a corresponding cam head 146 during a portion of a rotational cycle thereof. According to some embodiments, stem proximal portion 164 is formed with a frustoconical profile (see FIGS. 4A-4C). According to some embodiments, at least one of the plurality of stems 162 comprises stem proximal portion 164.

According to some embodiments, stem 162 comprises a stem aperture 170, adapted to receive a split pin 176 therein. According to some embodiments, seal assembly 160 further comprises a gasket 174 engaged with stem 162. Gasket 174 is configured to contact and support spring 178, so as to prevent displacement of the proximal end (not numbered) of spring 178 along stem 162 in the proximal direction.

According to some embodiments, gasket 174 comprises an O-ring. According to some embodiments, gasket 174 is disposed on stem 162 distally to stem aperture 170, so that split pin 176 is configured to contact gasket 174, for example when pushed by a corresponding spring 178, thereby preventing further displacement thereof along stem 162 in the proximal direction.

Split pin 176 comprises any type of pin, rod, nail or screw, adapted to be received within stem aperture 170.

According to some embodiments, stem 162 does not include a stem aperture 170, and split pin 176, including other type of pins, rods, nails, screws and the like, is affixed to stem 162, for example by welding, soldering or other method for rigid attachment known in the art.

According to some embodiments, spring 178 is a compressions spring, disposed around stem 162 along at least a portion of a region between gasket 174 and seal plug proximal surface 182 (see FIGS. 4A-4C). According to some embodiments, spring 178 is disposed around stem 162 along at least a portion of a region between gasket 174 and stem proximal retainer 166 (embodiment not shown).

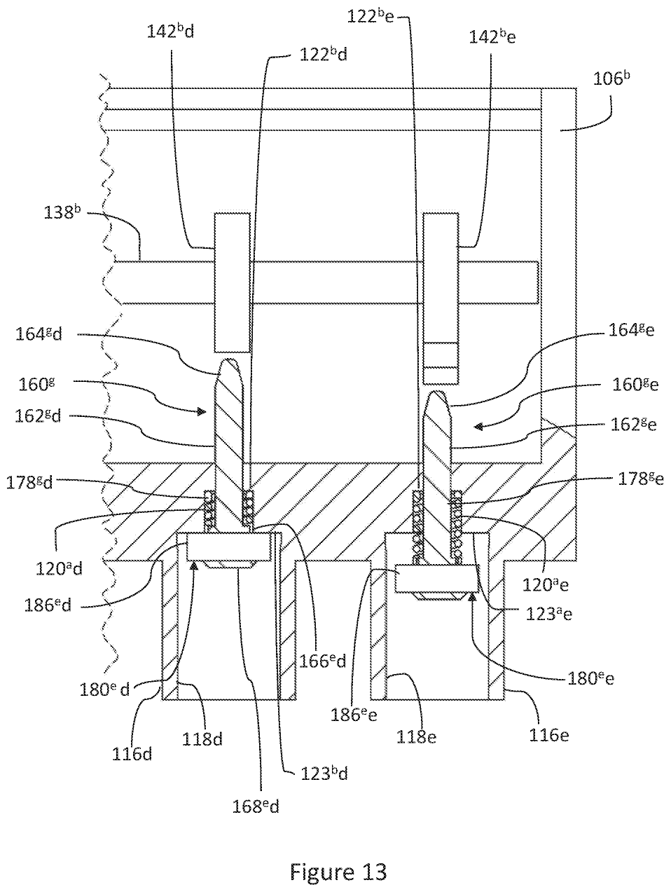

According to some embodiments, the diameter of the distal end (not numbered) of spring 178 is different from the diameter of the proximal end of spring 178 (see FIGS. 4A-4C). According to some embodiments, the diameter of the distal end of spring 178 is larger than the diameter of the proximal end of spring 178 (see FIGS. 4A-4C). According to some embodiments, the diameter of the distal end of spring 178 is smaller than the diameter of the proximal end of spring 178 (embodiment not shown). According to some embodiments, the diameter of the distal end of spring 178 is equal to the diameter of the proximal end of spring 178 (see FIG. 13).

According to some embodiments, the diameter of the proximal end of spring 178 is equal to or smaller than the diameter of gasket 174 (see FIGS. 4A-4C). According to some embodiments, the diameter of the distal end of spring 178 is equal to or smaller than the diameter of seal plug proximal surface 182 (see FIG. 4A). According to some embodiments, the diameter of the distal end of spring 178^{a} is larger than the diameter of seal plug proximal surface 182 (see FIG. 4B).

According to some embodiments, seal assembly 160^{b} is devoid of split pin 176, wherein gasket 174^{a} is affixed to stem 162 (see FIG. 4C), for example by gluing, welding, soldering or other method for rigid attachment known in the art. According to some embodiments, the proximal end of spring 178 is rigidly attached to gasket 174.

According to some embodiments, oscillating follower 148^{a} further comprises a follower extension 156, rigidly attached to follower base surface 152 (see FIG. 4C), configured to contact and push distally gasket 174, in parallel or instead of a similar contact between follower base surface 152 and stem proximal portion 164.

According to some embodiments, stem 162 does not include gasket 174, and split pin 176 is configured to contact and support spring 178, so as to prevent displacement of the proximal end (not numbered) of spring 178 along stem 162 in the proximal direction. According to some embodiments, the proximal end of spring 178 is rigidly attached to split pin 176.

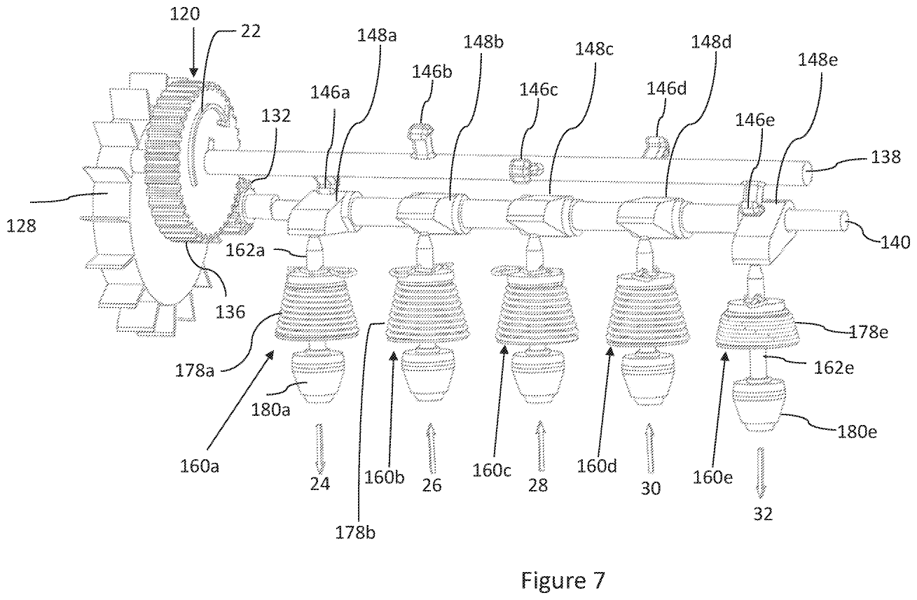

Reference is now made to FIG. 7, which constitutes a side view in perspective of the internal components of non-electric multi-channel valve for aqueous fluids or vapor 100, according to some embodiments. Housing 102 is removed from view in FIG. 7 for clarity. During operation, impeller 128 rotates in a direction opposite to arrow 22, for example due to aqueous fluid or vapor entering through inlet 114, hitting the vanes of impeller 128. First gear 132 is rigidly connected to impeller 128 via gear shaft 130, and rotates in the same direction as impeller 128. The teeth (not numbered) of first gear 132 are engaged with the teeth (not numbered) of second gear 136, causing second gear 136 to rotate in the direction of arrow 22. First shaft 138, affixed to second gear 136, therefore also rotates in the direction of arrow 22.

During rotational motion of first shaft 138, the plurality of cam elements 142 hit and push the plurality of oscillating followers 148 along various phases of their rotational motion. When each of the plurality of cam heads 146 starts to contact follower proximal surface 150, a corresponding oscillating follower 148 is pushed in an arcuate rotational motion in the opposite direction of arrow 22, and more precisely, pushed in a distal direction. During the arcuate motion of oscillating follower 148, follower base surface 152 contacts stem proximal portion 164, thereby pushing stem 162 distally.

The term “arcuate motion” and “arcuate rotational motion”, as used herein, are interchangeable.

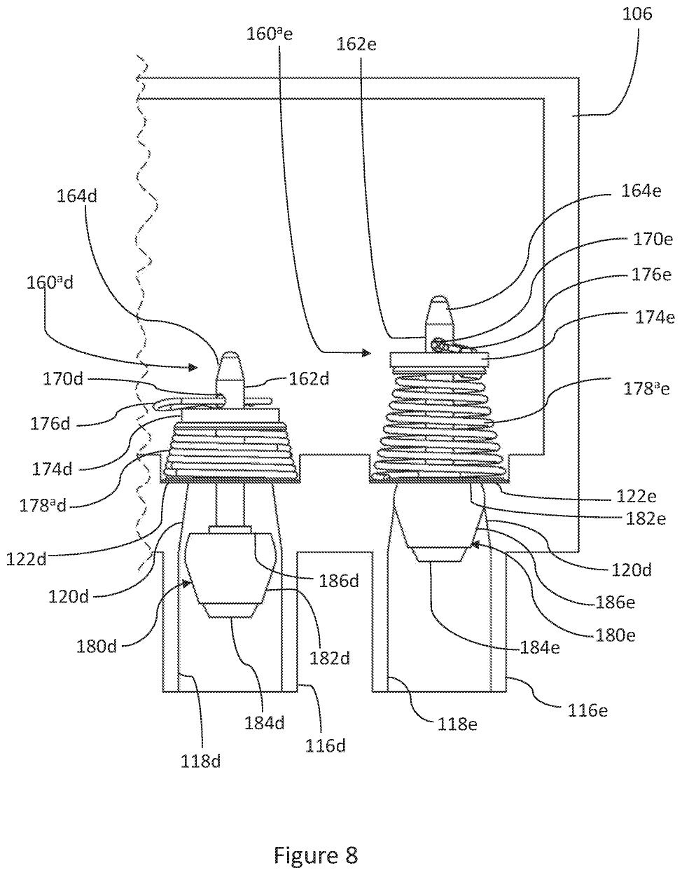

A specific example depicted in FIG. 7 is that of cam head 146a pushing follower proximal surface 150a, such that follower base surface 152a, by contacting stem proximal portion 164a, is pushing stem 162a in a distal direction indicated by arrow 24. Split pin 176a and seal plug 180a are rigidly attached to stem 162a, thereby moving in the distal direction there along. Spring 178a, bounded between housing 102 and gasket 174a, is gradually compressed against housing 102 (housing hidden from view in FIG. 7 for simplicity, but shown for example in FIG. 8) by the distal movement of gasket 174a. Spring 178e is shown in a fully compressed state, termed herein as a second position of seal assembly 160e.

When cam head 146 is no longer in contact with follower proximal surface 150, oscillating follower 148 is no longer exerting a pushing force on seal assembly 160, thereby allowing spring 178 to extend back to its original state, also referred to a first position. Extension of spring 178 pushes gasket 174 in the proximal direction, indicated by arrows 26, 28 and 30 for seal assemblies 160b, 160c and 160d, respectively. Split pin 176 is pushed by gasket 174 in the same proximal direction, along with stem 162 and seal plug 180 attached thereto.

Linear displacement in the proximal direction of seal assembly 160 is pushing oscillating follower 148 along an arcuate path in the direction of arrow 22. Thus, during each rotational cycle, oscillating follower 148 experiences at least two phases: (1) a phase during which oscillating follower 148, driven by a corresponding cam element 142, follows an arcuate path, rotating in a direction opposite to that of the rotation motion of first shaft 138, and (2) a phase during which oscillating follower 148, driven by a corresponding seal assembly 160, follows an arcuate path, rotating in the direction of the rotation motion of first shaft 138.

According to some embodiments, oscillating follower 148 experiences an additional third phase, following the second phase, of being idle and waiting for the first phase to begin during the next rotational cycle.

According to some embodiments, oscillating follower 148 is configured to follow an arcuate path in the second phase thereof, and more specifically, a path which does not extend to a complete rotation of oscillating follower 148 around second shaft 140, by adapting at least one of the following parameters or any combination of: the weight of oscillating follower 148, the frictional force acting between oscillating follower 148 and second shaft 140 or between oscillating follower 148 and clamp 158, the spring constant of spring 178, and the addition of another spring, such as a coil spring (not shown) connecting oscillating follower 148 to second shaft 140 or to clamp 158.

Reference is now made to FIG. 8, which constitutes a partial side view of two exemplary seal assemblies 160^{a}d and 160^{a}e, according to some embodiments. Each outlet 116 comprises an outlet channel 118, through which aqueous fluid or vapor may flow. According to some embodiments, outlet channel 118 is provided with a tubular straight profile. According to some embodiment, outlet channel 118 is provided with a varying diameter along at least a portion of its length. According to some embodiment, outlet channel comprises an outlet neck portion 120, formed with a varying diameter along a proximal portion of outlet channel 118 (see FIG. 8), such that the diameter of the proximal edge (not numbered) of outlet neck portion 120 is smaller than the diameter of the distal edge (not numbered) of outlet neck portion 120.

Each stem 162 of each seal assembly 160 is positioned within a corresponding outlet channel 118 such that their axes of symmetry (not shown) coincide. The distal edge (not numbered) of each spring 178 rests on housing 102, adjacent the proximal edge (not numbered) of outlet channel 118. According to some embodiments, housing 102 comprises a plurality of outlet supports 122, matching the amount of outlets 120 and aligned therewith. Each outlet support is formed around the corresponding outlet proximal edge 117, and. According to some embodiments, the distal edge of spring 178 rests on or supported by one of the plurality of outlet supports 122. According to some embodiments, each outlet support 122 is formed as a shoulder surrounding outlet proximal edge 117 (see FIGS. 9A-9B). According to some embodiments, outlet support 122 is co-planar with the inner wall portions (not numbered) of housing 102 between outlets 116 (embodiments not shown).

According to some embodiments, spring 178 is disposed around stem 162, along at least a portion of a region between seal plug 180 and stem proximal end 163, and more specifically, between outlet support 122 and gasket 174, such that the proximal end of spring 178 contacts gasket 174 during at least a portion of a rotational cycle without being attached thereto, and the distal end of spring 178 contacts outlet support 122 during at least a portion of a rotational cycle without being attached thereto. According to some embodiments, the proximal end of spring 178 is rigidly attached to gasket 174. According to some embodiments, the distal end of spring 178 is rigidly attached to outlet support 122.

Each seal assembly 160 is movable between a first position and a second position. A first position is a position of seal assembly 160, in which seal plug 180 completely obstructs any flow of aqueous fluid or vapor through the corresponding outlet channel 118. A second position is a position of seal assembly 160, in which seal plug 180 is positioned so as to allow the maximal flow rate through the corresponding outlet channel 118, relative to any other optional position of seal plug 180 during a rotational cycle. A series of intermediate transitional positions between a first positions and a second position may allow aqueous fluid or vapor to flow at flow rates which are equal to or less than the flow rate at the second position.

Seal assembly 160^{a}e in FIG. 8 is shown in a first position. Spring 178^{a}e is stretched between outlet support 122e and gasket 174e, such that seal plug 180e is forced in the proximal direction, to contact outlet neck portion 120e, thereby sealing outlet channel 118e. According to some embodiments, at least a portion of seal plug circumferential surface 186 contacts at least a portion of outlet neck portion 120 to seal outlet channel 118 in the first position (see FIG. 8). According to some embodiments, at least a portion of seal plug proximal surface 182 contacts at least a portion of outlet neck portion 120 or another portion of outlet channel 118, to seal outlet channel 118 in the first position (embodiment not shown in FIG. 8).

Seal assembly 160^{a}d in FIG. 8 is shown in a second position. Spring 178^{a}d is compressed between outlet support 122d and gasket 174d, such that seal plug 180d is transferred distally along outlet channel 118d, allowing aqueous fluid or vapor to flow there through. According to some embodiments, none of seal plug circumferential surface 186 or seal plug proximal surface 182 contacts outlet neck portion 120 or any other portion of outlet channel 118 in the second position.

According to some embodiments, non-electric multi-channel valve for aqueous fluids or vapor 100 is configured to provide continuous outflow, defined as providing fluid flow through at least one of the plurality of outlets 116, as long as aqueous fluid or vapor flows into housing 102 through inlet 114. In the exemplary embodiment depicted in FIG. 7, at least seal assembly 160e is in a position that enables fluid flow through a corresponding outlet (outlets not shown in FIG. 7). In the exemplary embodiment depicted in FIG. 1C, aqueous fluid or vapor can flow through at least outlet 116d. According to some embodiments, the orientation of the plurality of cam elements 142 extending from first shaft 138 is configured to provide continuous outflow. More specifically, the orientation of each of the plurality of cam elements 142 is chosen such that at each moment during each rotational cycle, at least one of the plurality of cam elements 142 pushes, directly or indirectly, a corresponding seal assembly 160 in a manner that will allow fluid flow through the corresponding outlet channel 118.

According to some embodiments, non-electric multi-channel valve for aqueous fluids or vapor 100 is configured to provide specific desired outflow pattern, defined as providing fluid flow through the plurality of outlets 116, wherein the duration and flow rate at each moment through each of the plurality of outlets 116, together form the outflow pattern. According to some embodiments, the orientation of each of the plurality of cam elements 142 is chosen such that it pushes, directly or indirectly, a corresponding seal assembly 160 in a manner that will allow fluid flow through the corresponding outlet channel 118 for a specific duration throughout a rotational cycle, thereby contributing to the creation of a desired outflow pattern.

According to some embodiments, the size and shape of the plurality of cam elements 142 is not identical, and the size and shape of each of the plurality of cam elements 142 is chosen such that it pushes, directly or indirectly, a corresponding seal assembly 160 along a path length in the distal direction, corresponding to the shape and size of the cam element 142, is configured to provide a specific flow rate through the corresponding outlet channel 118 during a specific duration throughout a rotational cycle, thereby contributing to the creation of a desired outflow pattern.

According to some embodiments, the size and shape of the plurality of seal assemblies 160 is not identical, and the size and shape of at least some of the components of each of the plurality of seal assemblies 160 is chosen such that when pushed, directly or indirectly, by a corresponding cam element 142, the displacement of the corresponding seal plug 180 is configured to provide a specific flow rate through the corresponding outlet channel 118 during a specific duration throughout a rotational cycle, thereby contributing to the creation of a desired outflow pattern.

According to some embodiments, non-electric multi-channel valve for aqueous fluids or vapor 100 is configured to provide continuous outflow such that the flow rate through all of the plurality of outlets 116 together, is constant at each moment of a rotational cycle.

According to some embodiments, non-electric multi-channel valve for aqueous fluids or vapor 100 is configured to provide continuous outflow such that the flow rate through all of the plurality of outlets 116 together, is varying, following a specific flow pattern.

According to some embodiments, non-electric multi-channel valve for aqueous fluids or vapor 100 is configured to provide specific desired outflow pattern, which is non-continuous or intermittent.

According to some embodiments, the orientation of cam elements 142 extending from first shaft 138 is configured to impose a desired flow pattern. The term “flow pattern”, as used herein, refers to a pattern or a scheme of the flow rate allowed through each of the plurality of outlet channels 118 at each moment during a rotational cycle.

Reference is now made to FIG. 9A-9B. FIGS. 9A-9B constitute top views of different embodiments of housing 102, wherein top wall 107 is removed from view for simplicity. FIGS. 9C and 9D constitute a cut-away view in perspective and a cross-sectional side view of the housing of FIG. 9B, respectively. FIG. 9A depicts an embodiment of housing 102, having outlet supports 122 surrounding the entrance of corresponding outlet channels 116, wherein each outlet support 122 is configured to support a corresponding spring 178 placed thereon.

According to some embodiments, each outlet support 122 further comprises at least one support rib 124. FIGS. 9B-9D depict an embodiment in which each outlet support 122 comprises four support ribs 124, configured to support at least one of the plurality of springs 178 placed thereon. According to some embodiments, a plurality of support ribs 124 extending from a single outlet support 122 form an opening there between (not numbered), configured to allow free passage and movement of stem 162 therein (see FIGS. 9B-9D).

According to some embodiments, non-electric multi-channel valve for aqueous fluids or vapor 100 is devoid of second shaft 140, such that cam elements 142 are configured to contact the seal assembly proximal ends 161, without intermediate mediating oscillating followers 148.

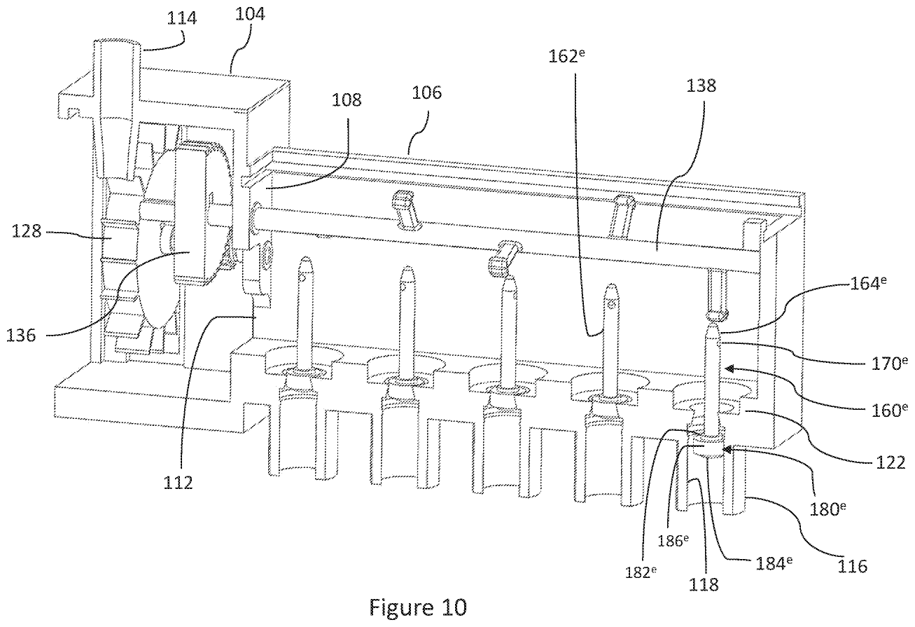

Reference is now made to FIG. 10-15, depicting different embodiments of non-electric multi-channel valve for aqueous fluids or vapor 100 devoid of second shaft 140. According to some embodiments, in the absence of second shaft 140 (see FIG. 10), each stem proximal portion 164 is configured to be contacted and pushed distally by cam head 146. Each of cam heads 146 is configured to engage a corresponding seal assembly proximal end 161 during a portion of a rotational cycle, thereby pushing seal assembly 160 in the distal direction until disengagement thereof. Thus, a rotational motion of first shaft 138 is translated to a liner motion of seal assembly 160. In particular, movement of seal assembly 160 from first position towards second position is facilitated directly by first shaft 138.

FIG. 10 constitutes a sectional view of non-electric multi-channel valve for aqueous fluids or vapor 100 devoid of second shaft 140, according to some embodiments. Springs 178^{e} and split pins 176 are removed from view in FIG. 10 for clarity. During a rotational motion of first shaft 138, each of cam elements 142 contact stem proximal portion 164^{e} during a portion of the rotational motion, thereby pushing stem 162^{e} distally. When cam head 146 is no longer in contact and no longer exerting a pushing force on seal assembly 160^{e}, spring 178 extends back to the first position.

According to some embodiments, seal plug 180^{e} is formed with a cylindrical shape (see FIGS. 10-11), having seal plug proximal surface 182^{e}, seal plug distal surface 184^{e}, and seal plug circumferential surface 186^{e}.

FIG. 11 constitutes a partial side view of two exemplary seal assemblies 160^{e}d and 160^{e}e, according to some embodiments. Each outlet 116 comprises an outlet channel 118, through which aqueous fluid or vapor may flow. According to some embodiment, outlet channel 118 comprises an outlet neck portion 120.

Each stem 162^{e} of seal assembly 160 is positioned within a corresponding outlet channel 118 such that their axes of symmetry (not shown) coincide. The distal edge (not numbered) of each spring 178^{e} rests on outlet support 122.

According to some embodiments, spring 178^{e} is disposed around stem 162, along at least a portion of a region between seal plug 180^{e} and the proximal end of stem 162^{e}, and more specifically in the specific embodiment of FIG. 11, between outlet support 122 and split pin 176, such that the proximal end of spring 178^{e} contacts split pin 176 during at least a portion of a rotational cycle without being attached thereto, and the distal end of spring 178^{e} contacts outlet support 122 during at least a portion of a rotational cycle without being attached thereto. According to some embodiments, the proximal end of spring 178^{e} is rigidly attached to split pin 176. According to some embodiments, the distal end of spring 178^{e} is rigidly attached to outlet support 122.

Each seal assembly 160^{e} is movable between the first position and the second position. Seal assembly 160^{e}e in FIG. 11 is shown in the first position. Spring 178^{e}e is stretched between outlet support 122e and split pin 176e, such that seal plug 180^{e}e is forced in the proximal direction, to contact outlet neck portion 120e, thereby sealing outlet channel 118e. According to some embodiments, neck portion 120e comprises a shoulder (not shown) against which seal plug proximal surface 182^{e} is pressed to seal outlet channel 118 in the first position.

Seal assembly 160^{e}d in FIG. 11 is shown in the second position. Spring 178^{e}d is compressed between outlet support 122d and split pin 176d, such that seal plug 180^{e}d is transferred distally along outlet channel 118d, allowing fluid to flow there through. According to some embodiments, none of seal plug circumferential surface 186^{e} or seal plug proximal surface 182^{e} contacts outlet neck portion 120 or any other portion of outlet channel 118 in the second position.

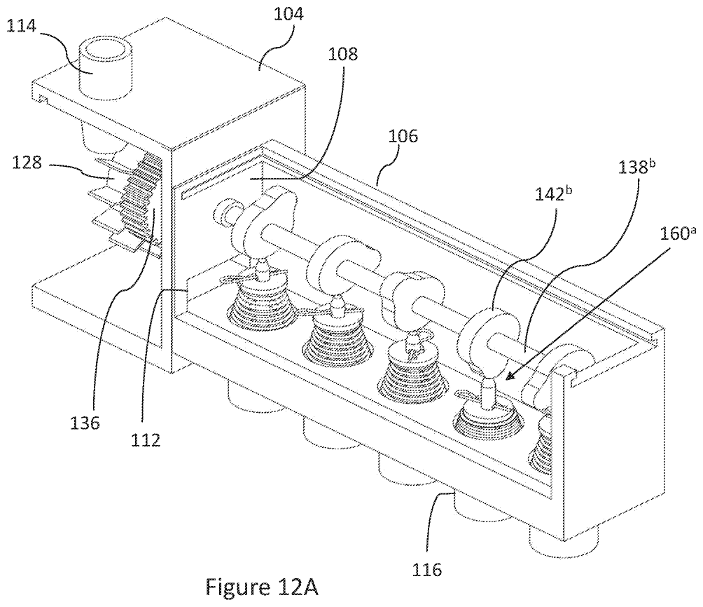

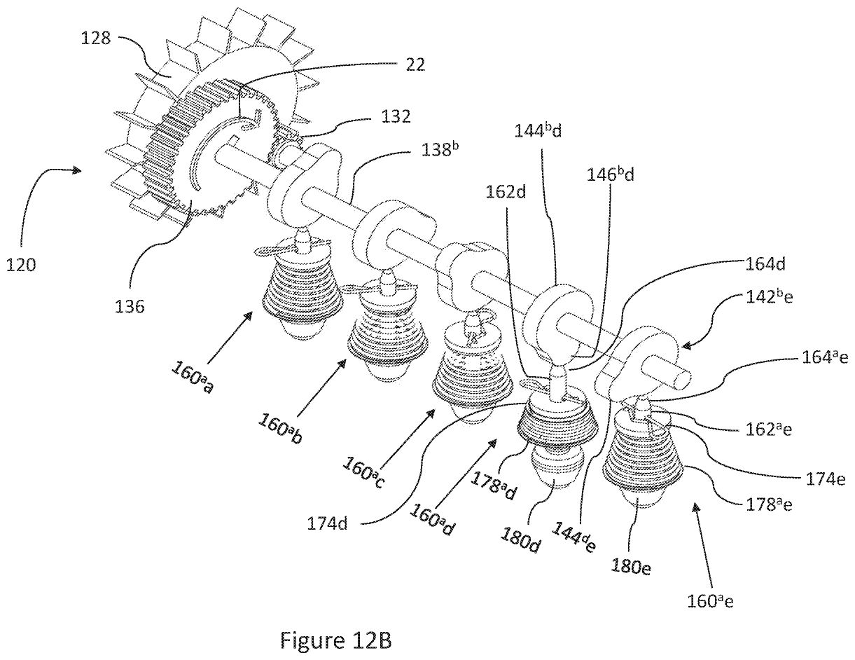

FIGS. 12A and 12B constitute a view in perspective of non-electric multi-channel valve for aqueous fluids or vapor 100 comprising first shaft 138^{b} (as presented in FIG. 3C), illustrated with and without housing 102, respectively. First shaft 138^{b} comprises a plurality of cam elements 142^{b}, each of which is having cam head 146^{b} formed as lobe extending from cam body 144^{b}. During a rotational motion of first shaft 138^{b}, each of cam elements 142^{b} engages stem proximal portion 164^{a} during a portion of the rotational motion, thereby pushing stem 162^{a} distally. When cam head 146 is no longer in contact and no longer exerting a pushing force on seal assembly 160^{a}, spring 178 extends back to the first position. Otherwise, non-electric multi-channel valve for aqueous fluids or vapor 100 as depicted in FIGS. 12A-12B comprises all embodiments previously described.

A specific example depicted in FIG. 12B is that of cam head 146^{b}d pushing stem proximal portion 164a, is pushing stem 162^{a}d in a distal direction. Split pin 176d and seal plug 180d are rigidly attached to stem 162d, thereby moving in the distal direction there along. Spring 178^{d}d, bounded between housing 102 (removed from view in FIG. 12B, but shown in FIG. 12A) and gasket 174d, is gradually compressed against housing 102 by the distal movement of gasket 174d. Spring 178d is fully compressed, being in a second position seal assembly 160d.

According to some embodiments, spring 178 is an extension spring disposed around stem 162 along at least a portion of a region between seal plug 180 and stem proximal end 163, such that spring 178 is configured to move between an un-extended state in the first position, positioned between housing 102 and seal plug 180, and an extended state in the second position.

FIG. 13 constitutes a partial sectional view of two exemplary seal assemblies 160^{g}d and 160^{g}e having extension springs 178^{g}d and 178^{g}e, respectively, according to some embodiments.

Each outlet 116 comprises an outlet channel 118, through which aqueous fluid or vapor may flow. According to some embodiment, outlet channel comprises an outlet neck portion 120^{a}, having a neck distal shoulder 123^{a}.

Each stem 162^{g} of seal assembly 160^{g} is positioned within a corresponding outlet channel 118 such that their axes of symmetry (not shown) coincide. The proximal edge (not numbered) of each spring 178^{g} is positioned against a corresponding neck distal shoulder 123^{a}. The distal edge (not numbered) of each spring 178^{g} is positioned against a corresponding seal plug proximal surface 182^{g} or against a corresponding proximal retainer 166^{g}. According to some embodiments, the proximal edge of each spring 178^{g} is rigidly attached to corresponding neck distal shoulder 123^{a}. According to some embodiments, the distal edge of each spring 178^{g} is rigidly attached to the corresponding seal plug proximal surface 182^{g} or the corresponding proximal retainer 166^{g}.

Each seal assembly 160^{g} is movable between the first position and the second position. Seal assembly 160^{g}d in FIG. 13 is shown in the first position. Cam element 142^{b}d is not in contact with and is not pushing seal assembly 160^{g}d in the first position.

Spring 178^{g}d is un-extended between the proximal edge of neck portion 120^{a}d and seal plug proximal surface 182^{g}d, such that seal plug 180^{g}d is forced in the proximal direction, to press against neck distal shoulder 123^{a}d to seal outlet channel 118d in the first position.

Cam head 146^{b}e contacts and pushes seal assembly 160^{g}e towards the second position. Spring 178^{g}e is extended between the proximal edge of neck portion 120^{a}e and seal plug proximal surface 182^{g}e, such that seal plug 180^{e}e is transferred distally along outlet channel 118e, allowing aqueous fluid or vapor to flow there through.

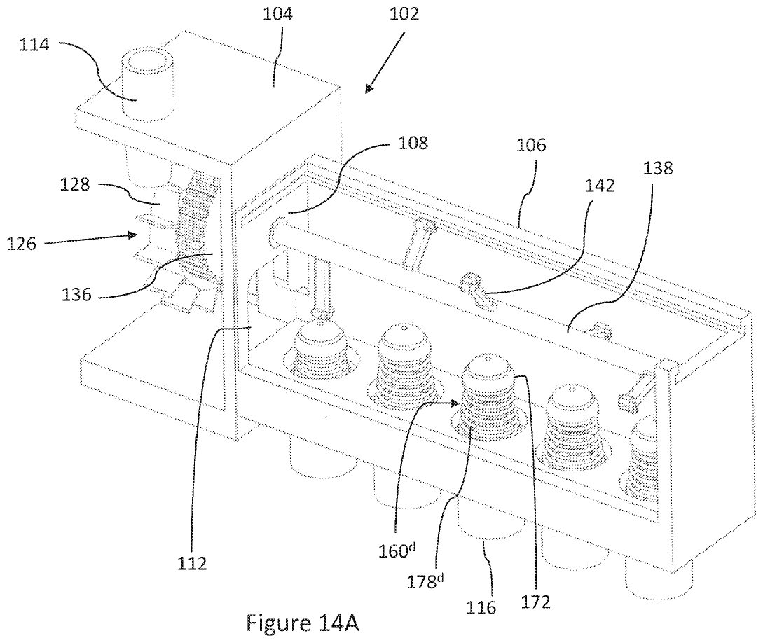

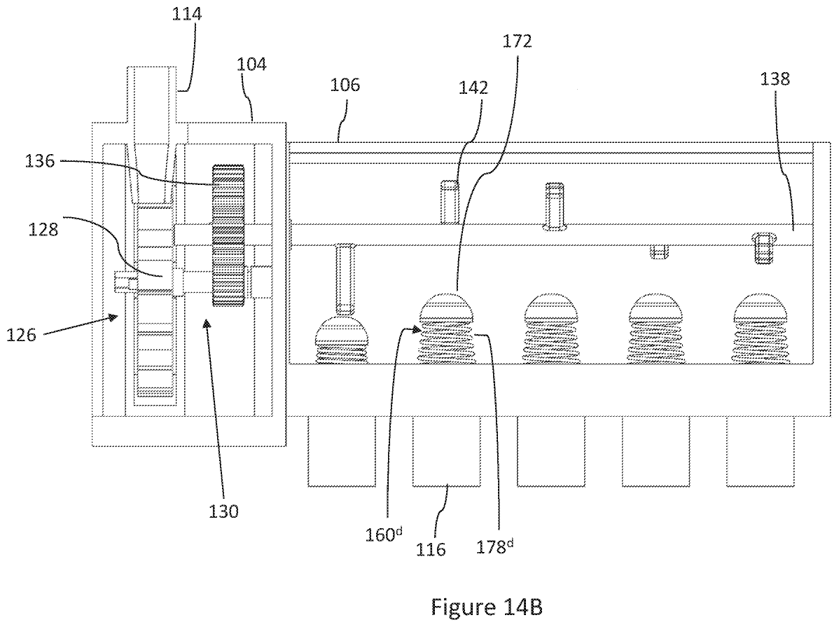

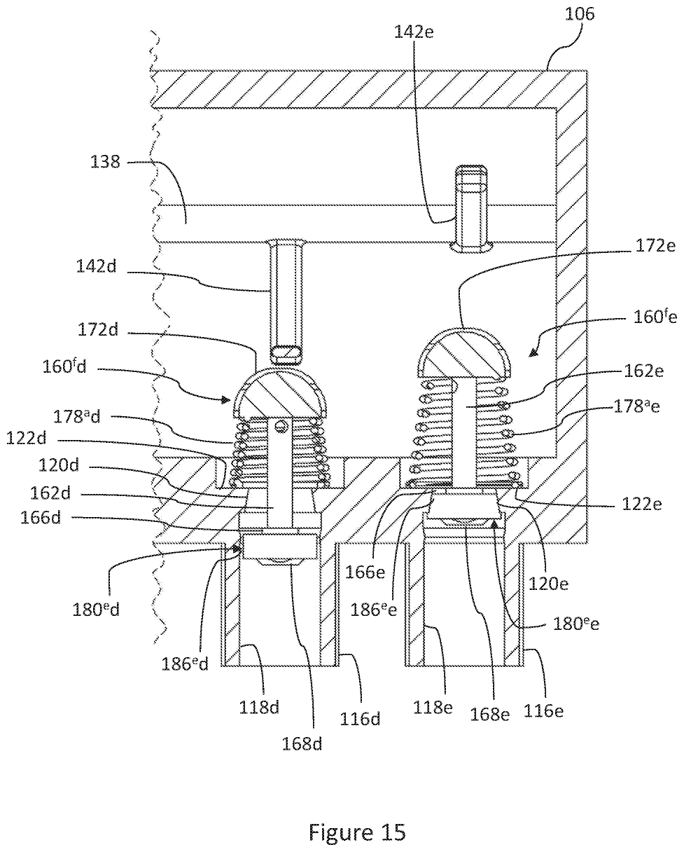

According to some embodiments, seal assembly 160 comprises seal proximal cover 172, rigidly attached to stem proximal end 162 (see FIGS. 14A-15). Cam elements 142 are configured to contact and push seal proximal covers 172 in the same manner as described for pushing stem proximal portions 164. According to some embodiments, seal proximal cover 172 is shaped in the form of a dome (see FIGS. 14A-15). According to some embodiments, at least one of the plurality of seal assemblies 160 comprises seal proximal cover 172.

According to some embodiments, seal assembly 160 is devoid of gasket 174 or split pin 176, wherein seal proximal cover 172 is configured to contact and support spring 178 instead of, so as to prevent displacement of the proximal end of spring 178 along stem 162 in the proximal direction. According to some embodiments, the proximal end of spring 178 is affixed to seal proximal cover 172.

FIGS. 14A and 14B constitute a sectional view in perspective and a cross-sectional side view of non-electric multi-channel valve for aqueous fluids or vapor 100 comprising seal assemblies 160^{d} equipped with seal proximal covers 172, according to some embodiments. During a rotational motion of first shaft 138, each of cam elements 142 contacts seal proximal covers 172 during a portion of the rotational motion, thereby pushing stem 162^{d} distally. When cam head 146 is no longer in contact with and no longer exerting a pushing force on seal assembly 160^{d}, spring 178 extends back to the first position.

FIG. 15 constitutes a partial cross-sectional side view of two exemplary seal assemblies 160^{f}d and 160^{f}e, according to some embodiments. Each outlet 116 comprises an outlet channel 118, through which aqueous fluid or vapor may flow. According to some embodiment, outlet channel comprises an outlet neck portion 120.

Each stem 162^{d} of seal assembly 160^{d} is positioned within a corresponding outlet channel 118 such that their axes of symmetry (not shown) coincide. The distal edge (not numbered) of each spring 178^{a} rests on outlet support 122. Each stem proximal end 163^{d} is rigidly attached to proximal cover 172.

According to some embodiments, spring 178^{a} is disposed around stem 162, along at least a portion of a region between seal plug 180^{e} and stem proximal end 163^{e}, and more specifically in the specific embodiment of FIG. 15, between outlet support 122 and proximal cover 172, such that the proximal end of spring 178^{a} contacts proximal cover 172 during at least a portion of a rotational cycle without being attached thereto, and the distal end of spring 178^{a} contacts outlet support 122 during at least a portion of a rotational cycle without being attached thereto. According to some embodiments, the proximal end of spring 178^{a} is rigidly attached to proximal cover 172. According to some embodiments, the distal end of spring 178^{a} is rigidly attached to outlet support 122.

Each seal assembly 160^{f} is movable between the first position and the second position. Seal assembly 160^{f}e in FIG. 15 is shown in the first position. Spring 178^{f}e is stretched between outlet support 122e and proximal cover 172e, such that seal plug 180^{e}e is forced in the proximal direction, to contact outlet neck portion 120e, thereby sealing outlet channel 118e.

Seal assembly 160^{f}d in FIG. 15 is shown in the second position. Spring 178^{a}d is compressed between outlet support 122d and proximal cover 172d, such that seal plug 180^{e}d is transferred distally along outlet channel 118d, allowing aqueous fluid or vapor to flow there through.

According to some embodiments, housing 102 comprises a plurality of outlets 116, such that all outlets are oriented in the same directions, such as depicted in FIGS. 1A-1C. According to some embodiments, housing 102 comprises a plurality of outlets 116, such that at least two of the plurality of outlets 116 are oriented in different directions.

According to some embodiments, each couple of adjacent outlets 116 of the plurality of outlets 116 are spaced from one another at an equal distance (see FIGS. 1A-1C). According to some embodiments, at least two couples of adjacent outlets 116 of the plurality of outlets 116 are spaced from one another at unequal distances (embodiment not shown).

According to some embodiments, the diameter of all outlets 116 is identical. According to some embodiments, at least two of the plurality of outlets 116 have different diameters.

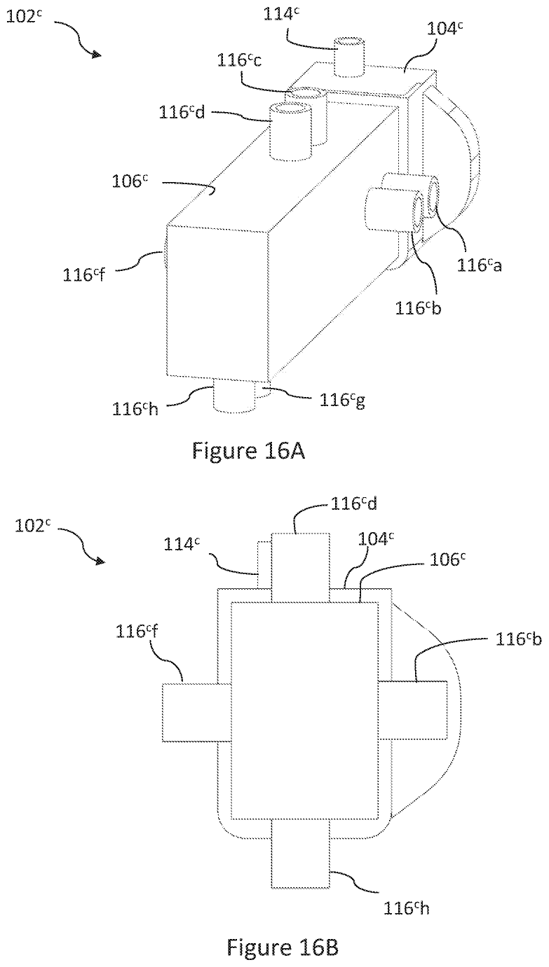

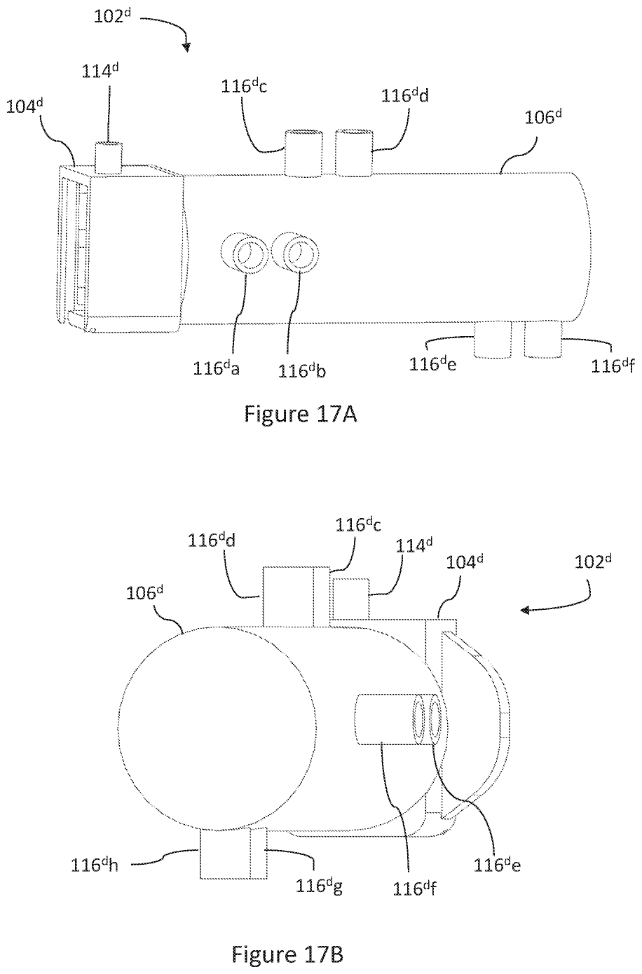

Reference is now made to FIG. 16A-17B, depicting different embodiments of housing 102, having varying configurations of outlets 116^{c}. FIGS. 16A-16B constitute a view in perspective and a front view, respectively, of housing 102^{c} having a plurality of outlets 116^{c} oriented in different directions, according to some embodiments. Housing 102^{c} comprises a first housing portion 104^{c} and a second housing portion 106^{c}, such that second housing portion is formed with a rectangular profile having four facets (not numbered). According to some embodiments, at least two of the facets of second housing portion 106^{c} include at least one outlet 116^{c} thereon. In the exemplary embodiment depicted in FIGS. 16A-16B, each facet of second housing portion 106^{c} includes a pair of outlets 116^{c}: a first facet (not numbered) includes outlets 116^{a}a and 116^{a}b, a second facet (not numbered) includes outlets 116^{a}c and 116^{a}d, a third facet (not numbered) includes outlets 116^{a}e (hidden from view) and 116^{a}f, and fourth facet (not numbered) includes outlets 116^{a}g and 116^{a}h.

According to some embodiments, at least one facet of second housing portions 106^{c} includes a plurality of outlets 116^{c}, such that at least two outlets 116^{c} are positioned at the same distance from at least one edge of the facet (see for example outlets 116^{a}a and 116^{a}b in FIG. 16A). According to some embodiments, at least one facet of second housing portions 106^{c} includes a plurality of outlets 116^{c}, such that at least two outlets 116^{c} are positioned at different distances from at least one edge of the facet (embodiment not shown).

FIGS. 17A-17B constitute a view in perspective and a front view, respectively, of housing 102^{d} having a plurality of outlets 116^{d} oriented in different directions, according to some embodiments. Housing 102^{d} comprises a first housing portion 104^{d} and a second housing portions 106^{d}, such that second housing portion is formed as cylinder. According to some embodiments, at least two of the plurality of outlets 116^{d} are positioned at different angles relative to a center-axis (not shown) of second housing portion 106^{d}, along its cylindrical circumference.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although the invention is described in conjunction with specific embodiments thereof, it is evident that numerous alternatives, modifications and variations that are apparent to those skilled in the art may exist. It is to be understood that the invention is not necessarily limited in its application to the details of construction and the arrangement of the components and/or methods set forth herein. Other embodiments may be practiced, and an embodiment may be carried out in various ways. Accordingly, the invention embraces all such alternatives, modifications and variations that fall within the scope of the appended claims.

1.-30. (canceled)

31. A non-electric multi-channel valve for aqueous fluids or vapor comprising:
(i) a housing having an inlet and a plurality of outlets, each of the plurality of outlets having an outlet proximal edge;
(ii) a mechanical driving mechanism connected to and rotatable within the housing;
(iii) a first shaft attached to the mechanical driving mechanism, the first shaft comprising a plurality of cam elements matching the amount of the plurality of outlets and aligned therewith, wherein the plurality of cam elements are rigidly attached to the first shaft, and wherein each of the plurality of cam elements comprises a cam body and a cam head; and
(iv) a plurality of seal assemblies matching the amount of the plurality of outlets and aligned therewith, each of the plurality of seal assemblies having a seal assembly proximal end and further comprising:
a stem having a stem proximal end;
a seal plug attached to the stem, and
a spring disposed around the stem, along at least a portion of a region between the seal plug and the stem proximal end,
wherein the mechanical driving mechanism is configured to be powered by the aqueous fluids or vapor flowing into the housing through the inlet and out of the housing through at least one of the plurality of outlets;
wherein the first shaft is configured to rotate within the housing;
wherein at least two of the cam heads of the plurality of cam elements project radially from the first shaft at different orientations, and
wherein each of the plurality of seal assemblies is configured to move between a first position and a second position, upon being intermittently pushed, directly or indirectly, by a corresponding cam element.

32. The non-electric multi-channel valve for aqueous fluids or vapor of claim 31, wherein the orientation of the plurality of cam elements extending from the first shaft is configured to provide continuous outflow.

33. The non-electric multi-channel valve for aqueous fluids or vapor of claim 31, wherein the mechanical driving mechanism comprises an impeller aligned with the inlet, and a gear train attached to the impeller.

34. The non-electric multi-channel valve for aqueous fluids or vapor of claim 33, wherein the gear train comprises:
(i) a gear shaft affixed to the impeller;
(ii) a first gear attached to the gear shaft, configured to rotate therewith; and
(iii) a second gear engaged with and configured to be driven by the first gear,
wherein the first shaft is rigidly connected to the second gear, and is configured to rotate therewith.

35. The non-electric multi-channel valve for aqueous fluids or vapor of claim 31, wherein each of the plurality seal assemblies further comprises a proximal retainer and a distal retainer, rigidly attached to the stem, wherein a corresponding seal plug of the plurality of seal plugs is retained between the proximal retainer and the distal retainer.

36. The non-electric multi-channel valve for aqueous fluids or vapor of claim 31, wherein each of the plurality of seal plugs is formed with a cylindrical convexly curved shape.

37. The non-electric multi-channel valve for aqueous fluids or vapor of claim 31, wherein each of the plurality of seal assemblies further comprises a split pin, and wherein a corresponding stem of the plurality of stems further comprises a stem aperture, configured to receive one of the plurality of split pins.

38. The non-electric multi-channel valve for aqueous fluids or vapor of claim 31, wherein each of the plurality of springs is a compression spring.

39. The non-electric multi-channel valve for aqueous fluids or vapor of claim 31, wherein the housing further comprises a plurality of outlet supports matching the amount of the plurality of outlets and aligned therewith, wherein each of the plurality of outlet supports is formed around a corresponding outlet proximal edge from the plurality of outlets.

40. The non-electric multi-channel valve for aqueous fluids or vapor of claim 39, wherein each of the plurality of outlet supports is formed as a shoulder.

41. The non-electric multi-channel valve for aqueous fluids or vapor of claim 39, wherein each of the plurality of outlet supports is configured to support a corresponding spring of the plurality of springs, placed thereon.

42. The non-electric multi-channel valve for aqueous fluids or vapor of claim 39, wherein each of the plurality of outlet supports further comprises at least one support rib, configured to support a corresponding spring of the plurality of springs, placed thereon.

43. The non-electric multi-channel valve for aqueous fluids or vapor of claim 31, wherein each of the plurality of springs is an extension spring.

44. The non-electric multi-channel valve for aqueous fluids or vapor of claim 31, wherein each of the plurality of outlets further comprises an outlet neck portion having a neck distal shoulder, and wherein each of the plurality of springs is positioned against the corresponding neck distal shoulder of the plurality of outlets.

45. The non-electric multi-channel valve for aqueous fluids or vapor of claim 31, wherein each of the plurality of cam heads is configured to engage a corresponding seal assembly proximal end from the plurality of seal assemblies during a portion of a rotational cycle, thereby pushing the corresponding seal assembly in the distal direction.

46. The non-electric multi-channel valve for aqueous fluids or vapor of claim 31, further comprising a second shaft rigidly attached to the housing, the second shaft comprising a plurality of oscillating followers matching the amount of the plurality of outlets, each of the plurality of oscillating followers having a follower proximal surface and a follower base surface, wherein each of the plurality of oscillating followers is rotatably attached to the second shaft, wherein the plurality of oscillating followers are devoid of springs or hydraulic elements, and wherein the plurality of oscillating followers are aligned with the plurality of cam elements and with the plurality of seal assemblies.

47. The non-electric multi-channel valve for aqueous fluids or vapor of claim 46, wherein each of the plurality of cam heads is configured to engage a corresponding follower proximal portion during a portion of a rotational cycle, resulting in an arcuate motion of the corresponding oscillating follower about the second shaft, and wherein the corresponding follower base surface is configured to push a corresponding seal assembly proximal end from the plurality of seal assemblies in a distal direction, during at least a portion of said arcuate motion.

48. The non-electric multi-channel valve for aqueous fluids or vapor of claim 31, wherein at least one of the plurality of stems further comprises a seal proximal cover, shaped in the form of a dome.

49. The non-electric multi-channel valve for aqueous fluids or vapor of claim 31, wherein at least two of the plurality of outlets are oriented in different directions.

50. The non-electric multi-channel valve for aqueous fluids or vapor of claim 31, wherein at least two couples of adjacent outlets of the plurality of outlets are spaced from one another at unequal distances.
